(19) United States
(12) Patent Application Publication
(10) Pub. No.: US 2025/0066995 A1
(43) Pub. Date: Feb. 27, 2025

(54) WATER REPELLENT COMPOSITION AND METHOD FOR PRODUCING SAME, AND WATER REPELLENT FIBER PRODUCT AND METHOD FOR PRODUCING SAME

(71) Applicant: NICCA CHEMICAL CO., LTD., Fukui-shi, Fukui (JP)

(72) Inventors: Kousuke Maeda, Fukui-shi, Fukui (JP); Atsushi Yonemoto, Fukui-shi, Fukui (JP)

(73) Assignee: NICCA CHEMICAL CO., LTD., Fukui-shi, Fukui (JP)

(21) Appl. No.: 18/725,386

(22) PCT Filed: Dec. 23, 2022
(86) PCT No.: PCT/JP2022/047736

§ 371 Date: Jun. 28, 2024

(30) Foreign Application Priority Data
Dec. 28, 2021 (JP) 2021-215090

(51) Int. Cl. D06M 15/643; D06M 15/248; D06M 15/263; D06M 101/06; D06M 101/32; D06M 101/34

(52) U.S. Cl. CPC D06M 15/643; D06M 15/248; D06M 15/263; D06M 2101/06; D06M 2101/32; D06M 2101/34; D06M 2200/10

(57) ABSTRACT

A water repellent composition which has excellent storage stability and enables the production of a water repellent fiber product that has excellent water repellency and excellent durable water repellency; a method for producing this water repellent composition; a water repellent fiber product; and a method for producing this water repellent fiber product. Examples provide: a water repellent composition which contains an organo-modified silicone (α) having a specific structure, a water repellent polymer (β) having a specific structure and an organic solvent (γ) that has a solubility in water within a specific range; a method for producing this water repellent composition; a water repellent fiber product; and a method for producing this water repellent fiber product.

### CROSS REFERENCE TO RELATED APPLICATIONS

This application is a US national stage filing under 35 U.S.C. § 371 of International Application No. PCT/JP2022/047736, filed Dec. 23, 2022, which claims priority to Japanese Patent Application No. 2021-215090, filed Dec. 28, 2021, each of which is incorporated herein by reference in its entirety.

### TECHNICAL FIELD

This disclosure relates to a water-repellent agent composition and a manufacturing method therefor, and a water-repellent fiber product and a manufacturing method therefor.

### BACKGROUND

Conventionally, to impart water repellency to fiber products, water-repellent agent compositions comprising a modified silicone and a water-repellent polymer are used.

Japanese Unexamined Patent Publication (Kokai) No. 2017-155095 discloses a water repellent aid comprising a specific organo-modified silicone, and WO 2019/163570 discloses a surface treatment agent comprising a water-repellent and oil-repellent polymer comprising repeating units derived from a fluorine-containing monomer and a non-fluorine monomer, a silicone polymer having a specific structure, and a liquid medium. In addition, WO 2020/158191 discloses a softener composition comprising a silicone polymer, a water-repellent polymer that is obtained by polymerization in the presence of the silicone polymer and at least one selected from the group consisting of fluorine-containing polymers and non-fluorine polymers, a liquid medium that is water or a mixture of water and an organic solvent, and an emulsifier, wherein the silicone polymer is in an amount of 20% by weight or greater relative to a total of the silicone polymer and the water-repellent polymer.

In the techniques of Japanese Unexamined Patent Publication (Kokai) No. 2017-155095 and WO 2019/163570, an emulsion dispersion product of silicone and an emulsion dispersion product of a water-repellent polymer are mixed. However, this method has a problem of poor stability of the water-repellent agent composition caused by the method of mixing a plurality of emulsion dispersion systems. According to the technique described in WO 2020/158191, the problem of insufficient stability due to mixing of a plurality of emulsion dispersion products can be avoided. However, even with the technique described in WO 2020/158191, there is still room for improvement in the stability of the water-repellent agent composition. Further, there is room for improvement in water repellency in these known techniques.

It is therefore helpful to provide a water-repellent agent composition that allows the manufacture of water-repellent fiber products having excellent water repellency and durable water repellency and has excellent storage stability, a manufacturing method therefor, a water-repellent fiber product, and a manufacturing method therefor.

### SUMMARY

We thus provide:

[1]

A water-repellent agent composition, including an organo-modified silicone (α), a water-repellent polymer (β), and an organic solvent (γ), wherein the organo-modified silicone (α) is represented by general formula (1):

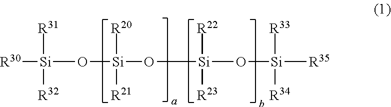

where in formula (1),
R²⁰, R²¹, and R²² each independently represent a hydrogen atom, a methyl group, an ethyl group, or an alkoxy group having 1 to 4 carbon atoms,
R²³ represents a hydrocarbon group having 8 to 40 carbon atoms comprising an aromatic ring, or an alkyl group having 8 to 40 carbon atoms,
R³⁰, R³¹, R³², R³³, R³⁴, and R³⁵ each independently represent a hydrogen atom, a methyl group, an ethyl group, an alkoxy group having 1 to 4 carbon atoms, a hydrocarbon group having 8 to 40 carbon atoms comprising an aromatic ring, or an alkyl group having 8 to 40 carbon atoms,
a represents an integer of 0 or greater; b represents an integer of 1 or greater; (a+b) is 10 to 200; when a is 2 or greater, each of R²⁰ and R²¹ present in plurality may be identical or different; and when b is 2 or greater, each of R²² and R²³ present in plurality may be identical or different,
the water-repellent polymer (β) comprises a constituent unit derived from a monomer (A-1) represented by general formula (A-1):

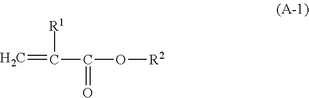

where in formula (A-1),
R¹ represents a hydrogen atom or a methyl group, and
R² represents a monovalent hydrocarbon group having 12 or more carbon atoms that may comprise a substituent, and/or a constituent unit derived from a monomer (A-f) represented by general formula (A-f):

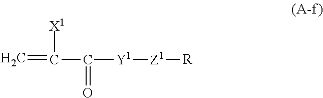

where in formula (A-f),
X¹ represents a hydrogen atom, a monovalent organic group, or a halogen atom,
Y¹ represents —O— or —NH—,
Z¹ represents a direct bond or a divalent organic group, and
R represents a fluoroalkyl having 1 to 20 carbon atoms, and
the organic solvent (γ) is an organic solvent in which an amount of water required to dissolve 1 g of the organic solvent at 20° C. is more than 10 mL.
   [2]

The water-repellent agent composition according to Aspect 1 above, wherein an amount of the organo-modified silicone (α) relative to a total of 100 parts by mass of the organo-modified silicone (α) and the water-repellent polymer (β) is 10 to 90 parts by mass.

[3]

The water-repellent agent composition according to Aspect 1 or 2 above, wherein the water-repellent polymer (β) further includes a constituent unit derived from a monomer (VC) of one or more selected from the group consisting of vinyl chloride and vinylidene chloride.

[4]

The water-repellent agent composition according to any of Aspects 1 to 3 above, wherein the water-repellent polymer (β) further includes a constituent unit derived from a monomer (A-2) represented by general formula (A-2):

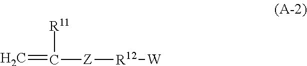

where in formula (A-2),
R¹¹ represents a hydrogen atom or a methyl group,
R¹² represents a divalent hydrocarbon group having 1 to 6 carbon atoms,
Z represents an ester group or an amide group, and
W represents a group represented by —CO—R¹³ (wherein R¹³ represents a monovalent hydrocarbon group having 1 to 4 carbon atoms), a —NH—CO—NH₂ group, or a group represented by formula (A-3):

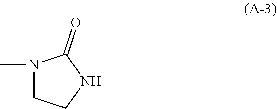

[5]

The water-repellent agent composition according to any of Aspects 1 to 4 above, wherein the water-repellent polymer (β) further includes a constituent unit derived from a reactive activator (B) of at least one selected from the group consisting of
(B1) a compound having a HLB of 7 to 18, represented by general formula (I-1):

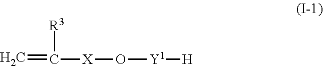

where in formula (I-1), R³ represents a hydrogen atom or a methyl group; X represents a linear or branched alkylene group having 1 to 6 carbon atoms; and Y¹ represents a divalent group comprising an alkyleneoxy group having 2 to 4 carbon atoms,
(B2) a compound having a HLB of 7 to 18, represented by general formula (II-1):

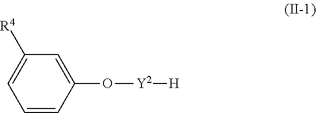

where in formula (II-1), R⁴ represents a monovalent unsaturated hydrocarbon group having 13 to 17 carbon atoms comprising a polymerizable unsaturated group; and Y² represents a divalent group comprising an alkyleneoxy group having 2 to 4 carbon atoms, and
(B3) a compound having a HLB of 7 to 18 and an alkylene oxide having 2 to 4 carbon atoms added to an oil or fat comprising a hydroxyl group and a polymerizable unsaturated group.
   [6]

A water repellent aid for an acrylic water-repellent agent, including an organo-modified silicone (α) and an organic solvent (γ), wherein the organo-modified silicone (α) is represented by general formula (1):

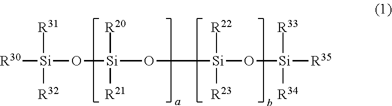

where in formula (1),
R²⁰, R²¹, and R²² each independently represent a hydrogen atom, a methyl group, an ethyl group, or an alkoxy group having 1 to 4 carbon atoms,
R²³ represents a hydrocarbon group having 8 to 40 carbon atoms comprising an aromatic ring or an alkyl group having 8 to 40 carbon atoms,
R³⁰, R³¹, R³², R³³, R³⁴, and R³⁵ each independently represent a hydrogen atom, a methyl group, an ethyl group, an alkoxy group having 1 to 4 carbon atoms, a hydrocarbon group having 8 to 40 carbon atoms comprising an aromatic group, or an alkyl group having 8 to 40 carbon atoms,
a represents an integer of 0 or greater; b represents an integer of 1 or greater; (a+b) is 10 to 200; when a is 2 or greater, each of R²⁰ and R²¹ present in plurality may be identical or different; and when b is 2 or greater, each of R²² and R²³ present in plurality may be identical or different, and
the organic solvent (γ) is an organic solvent in which an amount of water required to dissolve 1 g of the organic solvent at 20° C. is more than 10 mL.
   [7]

A manufacturing method for the water-repellent agent composition according to any of Aspects 1 to 5 above, including a mixing step of mixing an emulsion dispersion body comprising the organo-modified silicone (α) and the organic solvent (γ) with an emulsion dispersion body comprising the water-repellent polymer (β).

[8]

A manufacturing method for the water-repellent agent composition according to any of Aspects 1 to 5 above, including a mixing step of mixing an emulsion dispersion body including the organo-modified silicone (α) and the organic solvent (γ) with a monomer component that is a raw material of the water-repellent polymer (β), and a polymerization step of polymerizing the monomer component after the mixing step and/or during the mixing step to generate the water-repellent polymer (β).

[9]

A manufacturing method for the water-repellent agent composition according to any of Aspects 1 to 5 above, including a mixing step of mixing the organo-modified silicone (α), a monomer component that is a raw material of the water-repellent polymer (β), and the organic solvent (γ), and a polymerization step of polymerizing the monomer component after the mixing step and/or during the mixing step to generate the water-repellent polymer (β).

A water-repellent fiber product, including a fiber product and the water-repellent agent composition according to any of Aspects 1 to 5 above deposited on the fiber product.

A manufacturing method for a water-repellent fiber product, including a step of treating a fiber product with a treatment liquid including the water-repellent agent composition according to any of Aspects 1 to 5 above.

We provide a water-repellent agent composition that allows the manufacture of water-repellent fiber products having excellent water repellency and durable water repellency and has excellent storage stability, a manufacturing method therefor, a water-repellent fiber product, and a manufacturing method therefor can be provided.

### DETAILED DESCRIPTION

Hereinafter, our methods will be described in detail. However, this disclosure is not limited to the following examples.

### Water-Repellent Agent Composition

One aspect provides a water-repellent agent composition comprising an organo-modified silicone (α), a water-repellent polymer (β), and an organic solvent (γ).

### Organo-Modified Silicone (α)

The organo-modified silicone (α) is represented by general formula (1):

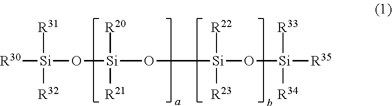

where in formula (1),
R²⁰, R²¹, and R²² each independently represent a hydrogen atom, a methyl group, an ethyl group, or an alkoxy group having 1 to 4 carbon atoms,
R²³ represents a hydrocarbon group having 8 to 40 carbon atoms comprising an aromatic ring, or an alkyl group having 8 to 40 carbon atoms,
R³⁰, R³¹, R³², R³³, R³⁴, and R³⁵ each independently represent a hydrogen atom, a methyl group, an ethyl group, an alkoxy group having 1 to 4 carbon atoms, a hydrocarbon group having 8 to 40 carbon atoms comprising an aromatic ring, or an alkyl group having 8 to 40 carbon atoms,
a represents an integer of 0 or greater; b represents an integer of 1 or greater; (a+b) is 10 to 200; when a is 2 or greater, each of R²⁰ and R²¹ present in plurality may be identical or different; and when b is 2 or greater, each of R²² and R²³ present in plurality may be identical or different. In the general formula (1), constituent units may be in any of block, random, and alternate arrangement.

In the general formula (1), the alkoxy group having 1 to 4 carbon atoms may be linear or branched. Examples of the alkoxy group having 1 to 4 carbon atoms include a methoxy group, an ethoxy group, a propoxy group, and a butoxy group.

In the general formula (1), examples of the hydrocarbon group having 8 to 40 carbon atoms comprising an aromatic ring include an aralkyl group having 8 to 40 carbon atoms, a group represented by general formula (2):

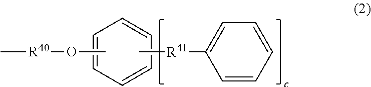

where in formula (2),
R⁴⁰ represents an alkylene group having 2 to 6 carbon atoms,
R⁴¹ represents a single bond or an alkylene group having 1 to 4 carbon atoms, and
c represents an integer of 0 to 3, and when c is 2 or 3, the R⁴¹ present in plurality may be identical or different, or a group represented by general formula (3):

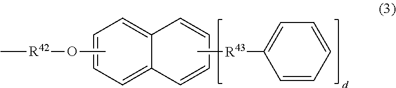

where in formula (3),
R⁴² represents an alkylene group having 2 to 6 carbon atoms,
R⁴³ represents a single bond or an alkylene group having 1 to 4 carbon atoms, and
d represents an integer of 0 to 3, and when d is 2 or 3, the R⁴³ present in plurality may be identical or different.

The alkylene group in the general formulas (2) and (3) may be linear or branched.

Examples of the above aralkyl group having 8 to 40 carbon atoms include a phenylethyl group, a phenylpropyl group, a phenylbutyl group, a phenylpentyl group, a phenylhexyl group, and a naphthylethyl group. Among these, a phenylethyl group and a phenylpropyl group are preferable from the viewpoint of ease of industrial manufacturing and ease of procurement.

In the group represented by the general formula (2), from the viewpoint of ease of industrial manufacturing and ease of procurement, R⁴⁰ is preferably an alkylene group having 2 to 4 carbon atoms, and c is preferably 0 or 1, and more preferably 0.

In the group represented by the general formula (3), from the viewpoint of ease of industrial manufacturing and ease of procurement, R⁴² is preferable an alkylene group having 2 to 4 carbon atoms, and d is preferably 0 or 1, and more preferably 0.

As the above hydrocarbon group having 8 to 40 carbon atoms comprising an aromatic ring, the aralkyl group having 8 to 40 carbon atoms and a group represented by the general formula (2) are preferable from the viewpoint of ease of industrial manufacturing and ease of procurement, and the aralkyl group having 8 to 40 carbon atoms is more preferable from the viewpoint of allowing improvement in water repellency of the resulting fiber product.

The above alkyl group having 8 to 40 carbon atoms may be linear or branched. Examples of the alkyl group having 8 to 40 carbon atoms include an octyl group, a nonyl group, a decyl group, an undecyl group, a dodecyl group, a myristyl group, a cetyl group, a stearyl group, a 1-hexacosenyl group (C26), a 1-octacosenyl group (C28), a 1-triacontenyl group (C30), and a 1-dotriacontenyl group (C32). As the alkyl group having 8 to 40 carbon atoms, an alkyl group having 12 to 36 carbon atoms is preferable, and an alkyl group having 16 to 30 carbon atoms is more preferable. The smaller the number of carbon atoms in the alkyl group, the greater the advantage in suppression of chalk marks on a fiber product and in storage stability. On the other hand, the larger the number of carbon atoms in the alkyl group, the greater the advantage in water repellency. From the viewpoint of balancing these performances, the number of carbon atoms in the range above is preferable.

From the viewpoint of ease of industrial manufacturing and ease of procurement, R³⁰, R³¹, R³², R³³, R³⁴, and R³⁵ in the general formula (1) are each independently preferably a hydrogen atom, a methyl group, an ethyl group, or an alkoxy group having 1 to 4 carbon atoms, and among these, more preferably a methyl group. For the same reasons, R²⁰, R²¹, and R²² are each independently preferably a hydrogen atom or a methyl group, and more preferably a methyl group.

In the general formula (1), a is an integer of 0) or greater. From the viewpoint of ease of industrial manufacturing, ease of procurement, and superior peel strength for the resin coating of the resulting fiber product, a is preferably 40 or less, and more preferably 30 or less.

In the general formula (1), (a+b) is 10 to 200. From the viewpoint of ease of industrial manufacturing and ease of procurement, (a+b) is preferably 20 to 100, and more preferably 40 to 60. When (a+b) is within the range above, the manufacture and handling of the silicone itself tend to be easier.

The organo-modified silicone (α) can be synthesized by a conventionally known method. The organo-modified silicone (α), for example, can be obtained by subjecting an aromatic compound having a vinyl group and/or an α-olefin to a hydrosilylation reaction with a silicone having a SiH group.

Examples of the above silicone having a SiH group include methyl hydrogen silicone with a polymerization degree of 10 to 200 or a copolymer of dimethylsiloxane and methyl hydrogen siloxane. Among these, methyl hydrogen silicone is preferable from the viewpoint of ease of industrial manufacturing and ease of procurement.

The above aromatic compound having a vinyl group, in R²³ in the general formula (1), is a compound from which a hydrocarbon group having 8 to 40 carbon atoms having an aromatic ring is derived. Examples of the aromatic compound having a vinyl group include styrene, α-methylstyrene, vinylnaphthalene, allyl phenyl ether, allyl naphthyl ether, allyl-p-cumyl phenyl ether, allyl-o-phenyl phenyl ether, allyl-tri(phenylethyl)-phenyl ether, and allyl-tri(2-phenylpropyl)phenyl ether.

The above α-olefin, in R²³ in the general formula (1), is a compound from which an alkyl group having 8 to 40 carbon atoms is derived. Examples of the α-olefin include α-olefins having 8 to 40 carbon atoms such as 1-octene, 1-nonene, 1-decene, 1-undecene, 1-dodecene, 1-tetradecene, 1-hexadecene, 1-octadecene, 1-hexacosene (C26), 1-octacosene (C28), 1-triacontene (C30), and 1-dotriacontene (C32).

The above hydrosilylation reaction may be carried out by reacting the silicone having a SiH group with the aromatic compound having a vinyl group and the α-olefin in stages or all at once, in the presence of a catalyst as needed.

The use amounts of the silicone having a SiH group, the aromatic compound having a vinyl group, and the α-olefin used in the hydrosilylation reaction can each be appropriately selected according to the SiH group equivalent weight or the number average molecular weight of the silicone having a SiH group.

Examples of the catalyst used in the hydrosilylation reaction include compounds of platinum and palladium. Among these, platinum compounds are preferable. Examples of platinum compounds include platinum (IV) chloride.

The reaction conditions of the hydrosilylation reaction are not particularly limited, and can be appropriately adjusted. The reaction temperature, for example, is 10 to 200° C. and preferably 50 to 150° C. The reaction time, for example, can be set to 3 to 12 h when the reaction temperature is 50 to 150° C.

The hydrosilylation reaction is preferably carried out in an inert gas atmosphere. Examples of the inert gas include nitrogen and argon. Although the reaction proceeds without a solvent, a solvent may be used. Examples of the solvent include dioxane, methyl isobutyl ketone, toluene, xylene, and butyl acetate.

In the water-repellent agent composition, the amount of the organo-modified silicone (α) relative to a total of 100 parts by mass of the organo-modified silicone (α) and the water-repellent polymer (β) is preferably the larger amount from the viewpoint of suppression of chalk marks, and is preferably the smaller amount from the viewpoint of (initial and durable) water repellency. The amount, from the viewpoint of balancing these performances, is preferably 10 to 90 parts by mass, more preferably 10 to 80 parts by mass, more preferably 15 to 70 parts by mass, and even more preferably 20 to 60 parts by mass.

### Water-Repellent Polymer (β)

The water-repellent polymer (β) comprises a constituent unit derived from a monomer (A-1) (hereinafter, also referred to as (A1) component) represented by general formula (A-1):

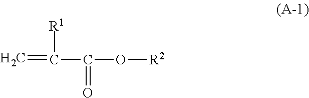

where in formula (A-1),
R¹ represents a hydrogen atom or a methyl group, and
R² represents a monovalent hydrocarbon group having 12 or more carbon atoms that may comprise a substituent, and/or a constituent unit derived from a monomer (A-f) (hereinafter, also referred to as (Af) component) represented by general formula (A-f):

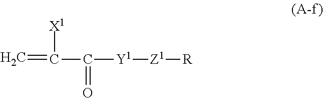

where in formula (A-f),
X¹ represents a hydrogen atom, a monovalent organic group, or a halogen atom,
Y¹ represents —O— or —NH—,
Z¹ represents a direct bond or a divalent organic group, and
R represents a fluoroalkyl group having 1 to 20 carbon atoms.

The water-repellent polymer (β) may be composed of only a constituent unit derived from the above (A1) component and/or (Af) component, or may further comprise one or more additional constituent units. At least one constituent unit of the water-repellent polymer (B) or a monomer corresponding to the constituent unit (i.e., forming the constituent unit) can comprise at least one functional group selected from the group consisting of functional groups capable of reacting with a crosslinking agent, for example, a hydroxyl group, an amino group, a carboxyl group, an epoxy group, and an isocyanate group. In this instance, the durable water repellency of the resulting fiber product can be further improved. The isocyanate group may form a blocked isocyanate group protected with a blocking agent. When the functional group is an amino group, the texture of the resulting fiber product can be further improved.

### Monomer (A-1)

The (A1) component comprises a monovalent hydrocarbon group having 12 or more carbon atoms that may comprise a substituent. The hydrocarbon group may be linear or branched, may be a saturated hydrocarbon group or an unsaturated hydrocarbon group, and may further comprise an alicyclic or aromatic ring. Among these, from the viewpoints of water repellency and texture, the hydrocarbon group is preferably linear, and more preferably a linear alkyl group. In this instance, water repellency is superior. When the monovalent hydrocarbon group having 12 or more carbon atoms comprises a substituent, examples of the substituent include one or more of a hydroxyl group, an amino group, a carboxyl group, an epoxy group, an isocyanate group, a blocked isocyanate group, and a (meth)acryloyloxy group. R² in the general formula (A-1) is preferably an unsubstituted hydrocarbon group.

The number of carbon atoms of the hydrocarbon group, from the viewpoint of water repellency, is preferably 12 to 40, more preferably 12 to 30, and even more preferably 12 to 24. The number of carbon atoms of the hydrocarbon group is particularly preferably 12 to 22. When the number of carbon atoms is in this range, water repellency and texture are particularly excellent. A particularly preferable hydrocarbon group is a linear alkyl group having 18 to 22 carbon atoms.

Examples of the (A1) component include stearyl (meth)acrylate, cetyl (meth)acrylate, lauryl (meth)acrylate, myristyl (meth)acrylate, pentadecyl (meth)acrylate, heptadecyl (meth)acrylate, nonadecyl (meth)acrylate, eicosyl (meth)acrylate, heneicosyl (meth)acrylate, and behenyl (meth)acrylate.

“(meth)acrylic acid ester” means an “acrylic acid ester” or a “methacrylic acid ester” corresponding thereto. The same meaning applies to “(meth)acrylic acid” and “(meth)acrylamide”.

The (A1) component is preferably a monofunctional (meth)acrylic acid ester monomer having one polymerizable unsaturated group per molecule.

The (A1) component may be of one type used alone, or may be of two or more types used in combination.

### Monomer (A-f)

The (Af) component above is generally a polymerizable compound comprising a fluoroalkyl group and an acrylate group, methacrylate group, or α-substituted acrylate group.

In the general formula (A-f), Z¹ represents a direct bond or a divalent organic group. In the present disclosure, an organic group means a group having 1 or more carbon atoms. Z¹, for example, may be a linear or branched aliphatic group (particularly, an alkylene group) having 1 to 20 carbon atoms, for example, a group represented by formula —(CH₂)ₙ— (where n is 1 to 10); alternatively, a group represented by formula —R^{b}(R^{a})N—SO₂— or formula —R^{b}(R^{a})N—CO— (where R^{a} is an alkyl group having 1 to 10 carbon atoms, and R^{b} is a linear alkylene group or branched alkylene group having 1 to 10 carbon atoms); alternatively, a group represented by formula —CH₂CH(OR^{c})CH₂—(Ar—O)ₚ— (where RC represents a hydrogen atom or an acyl group (for example, formyl or acetyl) having 1 to 10 carbon atoms, Ar represents an arylene group having an optional substituent, and p represents 0 or 1); alternatively, a group represented by formula —CH₂—Ar—(O)_{q}— (where Ar represents an arylene group having an optional substituent, and q is 0 or 1); or a —(CH₂)ₘ—SO₂—(CH₂)ₙ— group or —(CH₂)ₘ—S—(CH₂)ₙ— group (where m is 1 to 10, and n is 0 to 10).

X¹ represents a hydrogen atom, a monovalent organic group, or a halogen atom, and is preferably a hydrogen atom, a linear or branched alkyl group having 1 to 21 carbon atoms, a fluorine atom, a chlorine atom, a bromine atom, an iodine atom, a CFX^{a}X^{b} group (where X^{a} and X^{b} are each independently a hydrogen atom, a fluorine atom, a chlorine atom, a bromine atom, or an iodine atom), a cyano group, a linear or branched fluoroalkyl group having 1 to 21 carbon atoms, a substituted or unsubstituted benzyl group, or a substituted or unsubstituted phenyl group; more preferably a hydrogen atom, a methyl group, a chlorine atom, a bromine atom, an iodine atom, a fluorine atom, a cyano group, or a CF₃ group; even more preferably a methyl group or a chlorine atom; and particularly preferably a chlorine atom.

Z¹ is preferably a direct bond, an aliphatic group having 1 to 10 carbon atoms, an aromatic group or cycloaliphatic group having 6 to 18 carbon atoms, a —CH₂CH₂N(R^{e})SO₂— group (where R^{e} is an alkyl group having 1 to 4 carbon atoms), a —CH₂CH(OZ²)CH₂—(Ph—O)ₚ— group (where Z² represents a hydrogen atom or an acetyl group, Ph represents a phenylene group, and p is 0 or 1), a —(CH₂)ₙ—Ph—O— group (where Ph represents a phenylene group, and n is 0 to 10), or a —(CH₂)ₘ—SO₂—(CH₂)ₙ— group or —(CH₂)ₘ—S—(CH₂)ₙ— group (where m is 1 to 10, and n is 0 to 10).

Z¹ is more preferably an aliphatic group having 1 to 10 carbon atoms, an aromatic group or cycloaliphatic group having 6 to 18 carbon atoms, the —CH₂CH₂N(R^{e})SO₂— group above, the —CH₂CH(OZ²)CH₂—(Ph—O)ₚ— group above, the —(CH₂)ₙ—Ph—O— group above, the —(CH₂)ₘ—SO₂—(CH₂)ₙ— group above, or the —(CH₂)ₘ—S—(CH₂)ₙ— group above.

The aliphatic group comprising Z¹ in the general formula (A-f) is preferably an alkylene group (particularly, the number of carbon atoms is 1 to 4, for example, 1 or 2). The aromatic group or cycloaliphatic group may be substituted or unsubstituted. The S group or SO₂ group may be directly bonded to the R group.

In the general formula (A-f), R represents a fluoroalkyl group having 1 to 20 carbon atoms, and is preferably a linear or branched fluoroalkyl group having 1 to 20 carbon atoms. R is more preferably a perfluoroalkyl group. The number of carbon atoms in the R group is preferably 1 to 12, for example, 1 to 6, particularly 4 to 6, and especially 6. Examples of the R group include —CF₃, —CF₂CF₃, —CF₂CF₂CF₃, —CF(CF₃)₂, —CF₂CF₂CF₂CF₃, —CF₂CF(CF₃)₂, —C(CF₃)₃, —(CF₂)₄CF₃, —(CF₂)₂CF(CF₃)₂, —CF₂C(CF₃)₃, —CF(CF₃)CF₂CF₂CF₃, —(CF₂)₅CF₃, —(CF₂)₃CF(CF₃)₂, —(CF₂)₄CF(CF₃)₂, and —C₈F₁₇.

When the water-repellent polymer (β) contains a structural unit derived from the (A1) component and a structural unit derived from the (Af) component, the content ratio thereof as a ratio (A1)/(Af) of the mass of the (A1) component to the mass of the (Af) component for formulation is preferably 70/30 to 30/70. When (A1)/(Af) is within the above range, the resulting fiber product is satisfactory from the viewpoint of balancing water-repelling performance and cost.

The total mass ratio (which corresponds to the total mass ratio of a constituent unit derived from the (A1) component and a constituent unit derived from the (Af) component relative to all constituent units of the water-repellent polymer (β); the same applies to weights of other monomers) of the (A1) component and the (Af) component relative to the entire amount of monomer components that are raw materials of the water-repellent polymer (β) is preferably 60 to 100% by mass, more preferably 70 to 99% by mass, and even more preferably 75 to 98% by mass.

### Monomer (A-2

In one aspect, the water-repellent polymer (β) may further comprise a constituent unit derived from a monomer (A-2) (hereinafter, also referred to as (A2) component) represented by general formula (A-2):

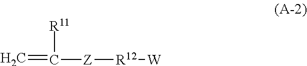

where in formula (A-2),
R¹¹ represents a hydrogen atom or a methyl group,
R¹² represents a divalent hydrocarbon group having 1 to 6 carbon atoms,
Z represents an ester group or an amide group, and
W represents a group represented by —CO—R¹³ (wherein R¹³ represents a monovalent hydrocarbon group having 1 to 4 carbon atoms), a —NH—CO—NH₂ group, or a group represented by formula (A-3):

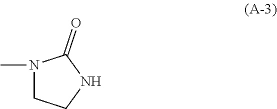

In the general formula (A-2), R1² may be linear or branched, may be a saturated hydrocarbon group or an unsaturated hydrocarbon group, and may further comprise an alicyclic ring.

In the formula (A-2), when Z is an ester group, it is preferable that R¹² be a hydrocarbon group having 2 to 4 carbon atoms and W be a group represented by —NH—CO—NH₂ or a group represented by the formula (A-3) above. When Z is an amide group, it is preferable that R¹² be a hydrocarbon group having 2 to 4 carbon atoms, W be a group represented by —CO—R¹³, and R¹³ have 1 or 2 carbon atoms.

The (A2) component above is not particularly limited. Examples include diacetone acrylamide, 2-methylpropenoic acid[2-(2-oxo-2-imidazolidinyl)ethyl], and N-[2-(2-oxoimidazolidin-3-yl)ethyl] methacrylamide. Among these, from the viewpoint of durable water repellency of the fiber product, the (A2) component above is preferably diacetone acrylamide or 2-methylpropenoic acid[2-(2-oxo-2-imidazolidinyl)ethyl].

The (A2) component above may be of one type used alone, or may be of two or more types used in combination.

In the water-repellent polymer (β), the content ratio of the constituent unit derived from the (A1) component to the constituent unit derived from the (A2) component as a ratio (A1)/(A2) of the mass of the (A1) component to the mass of the (A2) component for formulation is preferably 99.9/0.1 to 70/30, more preferably 99.8/0.2 to 80/20, and even more preferably 99.7/0.3 to 90/10. When (A1)/(A2) is within the above range, the resulting fiber product has more satisfactory durable water repellency and water repellency.

The total mass ratio of the (A1) component and the (A2) component relative to the entire amount of monomer components that are raw materials of the water-repellent polymer (B) is preferably 10 to 100% by mass, more preferably 20 to 95% by mass, and even more preferably 30 to 90% by mass.

### Reactive Activator (B)

The water-repellent polymer (β), in one aspect, can be obtained by emulsion polymerization or dispersion polymerization. From the viewpoint of allowing improvement in emulsion stability of the water-repellent polymer (β) in the water-repellent agent composition after polymerization, it is preferable that a monomer component that is a raw material of the water-repellent polymer (β) further comprise a reactive activator (B) (hereinafter, also referred as “(B) component”). The reactive activator (B) is at least one selected from the group consisting of

(B1) a compound having a HLB of 7 to 18 and represented by general formula (I-1):

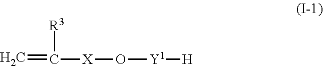

where in formula (I-1), R³ represents a hydrogen atom or a methyl group; X represents a linear or branched alkylene group having 1 to 6 carbon atoms; and Y¹ represents a divalent group comprising an alkyleneoxy group having 2 to 4 carbon atoms,

(B2) a compound having a HLB of 7 to 18 and represented by general formula (II-1):

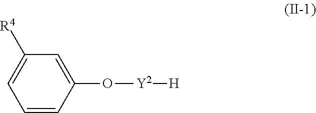

where in formula (II-1), R⁴ represents a monovalent unsaturated hydrocarbon group having 13 to 17 carbon atoms comprising a polymerizable unsaturated group; and Y² represents a divalent group comprising an alkyleneoxy group having 2 to 4 carbon atoms, and

(B3) a compound having a HLB of 7 to 18 and an alkylene oxide having 2 to 4 carbon atoms added to an oil or fat comprising a hydroxyl group and a polymerizable unsaturated group.

“Reactive activator” refers to a surfactant having radical reactivity, more specifically a surfactant comprising one or more polymerizable unsaturated group per molecule, and can be copolymerized with a monomer such as a (meth)acrylic acid ester.

The “HLB” is based on the Griffin HLB and a modification of Griffin's formula to the following formula. The hydrophilic group refers to an ethylene oxide group.

HLB=(hydrophilic group×20)/molecular weight

The HLBs of the compounds of (B1) to (B3) above are each 7 to 18, and preferably 9 to 15 from the viewpoint of emulsion stability (hereinafter, simply referred to as emulsion stability) during emulsion polymerization or dispersion polymerization of the water-repellent polymer (β), and in the water-repellent agent composition after polymerization. In addition, it is more preferable that two or more reactive activators (B) having different HLBs within the range above be used in combination, from the viewpoint of storage stability of the water-repellent agent composition.

In the reactive activator (B1) represented by the general formula (I-1) above, R³ is a hydrogen atom or a methyl group, and more preferably a methyl group from the viewpoint of copolymerizability with the (A1) component and/or the (Af) component.

In the general formula (I-1), X is a linear or branched alkylene group having 1 to 6 carbon atoms, and more preferably a linear alkylene group having 2 or 3 carbon atoms from the viewpoint of emulsion stability of the water-repellent polymer (β).

In the general formula (I-1), Y¹ is a divalent group comprising an alkyleneoxy group having 2 to 4 carbon atoms. The type, combination, and addition number of alkylene group in Y1 can be appropriately selected so that the HLB is within the range above. When the alkyleneoxy group is of two or more types, additional blocked structures or additional random structures can be included in each thereof.

The compound represented by the general formula (I-1) above is preferably a compound represented by general formula (I-2):

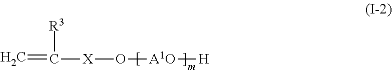

where in formula (I-2),
R³ represents a hydrogen atom or a methyl group,
X represents a linear or branched alkylene group having 1 to 6 carbon atoms,
A¹O represents an alkyleneoxy group having 2 to 4 carbon atoms, and
m is appropriately selected so that the HLB is within the range above; is an integer of 1 to 80 in one aspect; and when m is 2 or greater, the m number of A1O may be identical or different.

In the general formula (I-2), R³ is a hydrogen atom or a methyl group, and more preferably a methyl group from the viewpoint of copolymerizability with the (A1) component and/or the (Af) component.

In the general formula (I-2), X is a linear or branched alkylene group having 1 to 6 carbon atoms, and more preferably a linear alkylene group having 2 or 3 carbon atoms from the viewpoint of emulsion stability of the water-repellent polymer (β).

In the general formula (I-2), A¹O is an alkyleneoxy group having 2 to 4 carbon atoms. The type and combination of A¹O and the number m can be appropriately selected so that the HLB is with the range above. From the viewpoint of emulsion stability of the water-repellent polymer (β), m is preferably an integer of 1 to 80, and more preferably an integer of 1 to 60. When m is 2 or greater, the m number of A¹O may be identical or different. When A¹O is of two or more types, additional blocked structures or additional random structures can be included in each thereof.

The (B1) component represented by the general formula (I-2) above can be obtained by a conventionally known method but is not particularly limited. The (B1) component can be easily procured from commercial products, and examples can include “Latemul PD-420”, “Latemul PD-430”, and “Latemul PD-450” manufactured by Kao Corporation.

In the (B2) component represented by the general formula (II-1), R⁴ is a monovalent unsaturated hydrocarbon group having 13 to 17 carbon atoms comprising a polymerizable unsaturated group, and examples include a tridecenyl group, a tridecadienyl group, a tetradecenyl group, a tetradienyl group, a pentadecenyl group, a pentadecadienyl group, a pentadecatrienyl group, a heptadecenyl group, a heptadecadienyl group, and a heptadecatrienyl group. From the viewpoint of emulsion stability of the water-repellent polymer (β), R⁴ is more preferably a monovalent unsaturated hydrocarbon group having 14 to 16 carbon atoms.

Y² is a divalent group comprising an alkyleneoxy group having 2 to 4 carbon atoms. The type, combination, and addition number of alkyleneoxy group in Y² can be appropriately selected so that the HLB is within the range above. When the alkyleneoxy group is of two or more types, additional blocked structures or additional random structure can be included in each thereof. From the viewpoint of emulsion stability of the water-repellent polymer (β), the alkyleneoxy group is more preferably an ethyleneoxy group.

The compound represented by the general formula (II-1) above is preferably a compound represented by general formula (II-2):

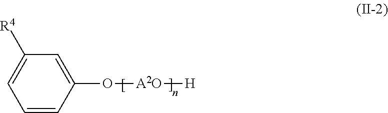

where in formula (II-2),
R⁴ represents a monovalent unsaturated hydrocarbon group having 13 to 17 carbon atoms comprising a polymerizable unsaturated group,
A²O represents an alkyleneoxy group having 2 to 4 carbon atoms, and
n can be appropriately selected so that the HLB is within the range above; specifically, is preferably an integer of 1 to 50; and when n is 2 or greater, then number of A²O may be identical or different.
R⁴ of the compound represented by the general formula (II-2) above includes the same R⁴ in the general formula (II-1) described above.

A²O is an alkyleneoxy group having 2 to 4 carbon atoms. From the viewpoint of emulsion stability of the water-repellent polymer (β), the type and combination of A²O and the number n can be appropriately selected so that the HLB is within the above range. From the viewpoint of emulsion stability of the water-repellent polymer (β), A²O is more preferably an ethyleneoxy group, and n is preferably an integer of 1 to 50, more preferably an integer of 5 to 20, and even more preferably an integer of 8 to 14. When n is 2 or greater, the n number of A²O may be identical or different. When A²O is of two or more types, additional blocked structures or additional random structures can be included in each thereof.

The (B2) component represented by the general formula (II-2) above can be synthesized by adding an alkylene oxide to the corresponding phenol comprising an unsaturated hydrocarbon group by a conventionally known method, and is not particularly limited. For example, the (B2) component can be synthesized by adding a predetermined amount of alkylene oxide at 120 to 170° C. under pressurization using an alkaline catalyst such as caustic soda or caustic potassium.

The corresponding phenol comprising an unsaturated hydrocarbon group above includes those existing as pure products extracted and purified from plants and mixtures thereof, in addition to industrially manufactured pure products and mixtures thereof. Examples include 3-[8(Z),11(Z),14-pentadecatrienyl]phenol, 3-[8(Z),11(Z)-pentadecadienyl]phenol, 3-[8(Z)-pentadecenyl]phenol, and 3-[11(Z)-pentadecenyl]phenol, which are extracted from cashew nut shells and collectively known as cardanol.

The (B3) component is a compound having a HLB of 7 to 18 and obtained by adding an alkylene oxide having 2 to 4 carbon atoms to an oil or fat comprising a hydroxyl group and a polymerizable unsaturated group. Examples of the oil or fat comprising a hydroxyl group and a polymerizable unsaturated group can include mono- or diglycerides of fatty acids that may comprise a hydroxy unsaturated fatty acid (such as palmitoleic acid, oleic acid, linoleic acid, α-linoleic acid, arachidonic acid, eicosapentaenoic acid, or docosapentaenoic acid) and triglycerides of fatty acids comprising at least one hydroxy unsaturated fatty acid (such as ricinoleic acid, ricinoelaidic acid, or 2-hydroxytetracosenoic acid). From the viewpoint of emulsion stability of the water-repellent polymer (β), the (B3) component is preferably an alkylene oxide adduct of a triglyceride of fatty acids comprising at least one hydroxy unsaturated fatty acid, more preferably an alkylene oxide adduct having 2 to 4 carbon atoms of castor oil (a triglyceride of fatty acids including ricinoleic acid), and even more preferably an ethylene oxide adduct of castor oil. The number of moles of alkylene oxide added can be appropriately selected so that the HLB is within the range above, and from the viewpoint of emulsion stability of the water-repellent polymer (β), is more preferably 20 to 50 mol, and even more preferably 25 to 45 mol. When the alkylene oxide is of two or more types, additional blocked structures or additional random structure can be included in each thereof.

The (B3) component can be synthesized by adding an alkylene oxide to an oil or fat comprising a hydroxyl group and a polymerizable unsaturated group by a conventionally known method, and is not particularly limited. For example, the (B3) component can be synthesized by adding a predetermined amount of alkylene oxide to a triglyceride of fatty acids including ricinoleic acid, i.e., castor oil, at 120 to 170° C. under pressurization using an alkaline catalyst such as caustic soda or caustic potassium.

The constituent ratio of monomers of the (B) component above in the water-repellent polymer (β) relative to the entire amount of monomer components constituting the water-repellent polymer (β), from the viewpoint of allowing improvements in water repellency of the resulting fiber product and emulsion stability during emulsion polymerization or dispersion polymerization of the water-repellent polymer (β) and in the composition after polymerization, is preferably 0.5 to 20% by mass, more preferably 1 to 15% by mass, and even more preferably 3 to 10% by mass.

### Monomer (C)

It is preferable that the water-repellent polymer (β), from the viewpoint of allowing improvement in durable water repellency of the resulting fiber product, further comprise a constituent unit derived from a monomer (C) (hereinafter, also referred to as (C) component) of at least one selected from the group consisting of (C1), (C2), (C3), and (C4) below.

(C1) A (meth)acrylic acid ester monomer (hereinafter, also referred to as (C1) component) represented by general formula (C-1):

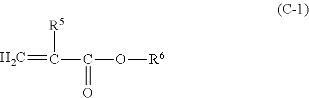

where in formula (C-1), R⁵ represents hydrogen or a methyl group, and R⁶ represents a monovalent chain hydrocarbon group having 1 to 11 carbon atoms comprising at least one functional group selected from the group consisting of a hydroxyl group, an amino group, a carboxyl group, an epoxy group, an isocyanate group, and a (meth)acryloyloxy group, however the number of (meth)acryloyloxy groups per molecule is 2 or less.

(C2) A (meth)acrylic acid ester monomer (hereinafter, also referred to as (C2) component) represented by general formula (C-2):

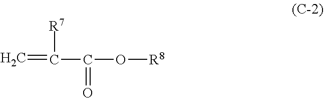

where in formula (C-2), R⁷ represents hydrogen or a methyl group, and R⁸ represents a monovalent cyclic hydrocarbon group having 1 to 11 carbon atoms that may comprise a substituent.

(C3) A (meth)acrylic acid ester monomer (hereinafter, also referred to as (C3) component) represented by general formula (C-3):

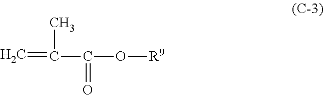

where in formula (C-3), R⁹ represents an unsubstituted monovalent chain hydrocarbon group having 1 to 4 carbon atoms

(C4) A (meth)acrylic acid ester monomer (hereinafter, also referred to as (C4) component) represented by general formula (C-4):

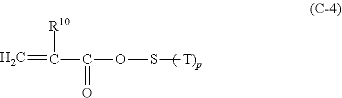

where in formula (C-4), R¹⁰ represents hydrogen or a methyl group, p represents an integer of 2 or greater, S represents a (p+1)-valent organic group, and T represents a monovalent organic group comprising a polymerizable unsaturated group.

The (C1) component above is a (meth)acrylic acid ester monomer comprising a monovalent chain hydrocarbon group having 1 to 11 carbon atoms comprising at least one functional group selected from the group consisting of a hydroxyl group, an amino group, a carboxyl group, an epoxy group, an isocyanate group, and a (meth)acryloyloxy group in the ester moiety. From the viewpoint of allowing a reaction with a crosslinking agent, the monovalent chain hydrocarbon group having 1 to 11 carbon atoms above preferably comprises at least one functional group selected from the group consisting of a hydroxyl group, an amino group, a carboxyl group, an epoxy group, and an isocyanate group. When a water-repellent polymer (β) having a constituent unit derived from the (C1) component comprising a group capable of reacting with any of these crosslinking agents and the crosslinking agent are used to treat a fiber product, durable water repellency of the resulting fiber product can be improved while maintaining texture thereof. The isocyanate group may be a blocked isocyanate group protected by a blocking agent.

The chain hydrocarbon group above may be linear or branched, and may be a saturated hydrocarbon group or an unsaturated hydrocarbon group. The chain hydrocarbon group may further comprise a substituent in addition to the functional group above. Among these, from the viewpoint of allowing improvement in durable water repellency of the resulting fiber product. the chain hydrocarbon group is preferably linear and/or a saturated hydrocarbon group.

Examples of specific (C1) components include 2-hydroxyethyl (meth)acrylate, dimethylaminoethyl (meth)acrylate, glycidyl (meth)acrylate, and 1,1-bis(acryloyloxymethyl)ethyl isocyanate. These monomers may be used individually, or may be used in combinations of two or more. Among these, from the viewpoint of allowing improvement in durable water repellency of the resulting fiber product, 2-hydroxyethyl (meth)acrylate, glycidyl (meth)acrylate, and 1,1-bis(acryloyloxymethyl)ethyl isocyanate are preferable. From the viewpoint of further improving texture of the resulting fiber product, dimethylaminoethyl (meth)acrylate is preferable.

The mass of the (C1) component for formulation relative to a total of 100 parts by mass of the mass of the (A1) component and the mass of the (Af) component for formulation, from the viewpoint of water repellency, is preferably 0.5 parts by mass or more, and more preferably 1 part by mass or more. The mass of the (C1) component for formulation relative to a total of 100 parts by mass of the mass of the (A1) component and the mass of the (Af) component for formulation, from the viewpoint of water repellency, is preferably 20 parts by mass or less, and more preferably 10 parts by mass or less.

The (C2) component above is a (meth)acrylic acid ester monomer comprising a monovalent cyclic hydrocarbon group having 1 to 11 carbon atoms in the ester moiety. Examples of the cyclic hydrocarbon group include an isobornyl group, a cyclohexyl group, and a dicyclopentanyl group. These cyclic hydrocarbon groups may comprise a substituent such as an alkyl group. However, when the substituent is a hydrocarbon group, a hydrocarbon group is selected so that the total number of carbon atoms of the substituent and the cyclic hydrocarbon group is 11 or less. In addition, it is preferable that the cyclic hydrocarbon group be directly bonded to the ester bond, from the viewpoint of improving durable water repellency. The cyclic hydrocarbon group may be alicyclic or aromatic, and when alicyclic, may be a saturated hydrocarbon group or an unsaturated hydrocarbon group. Examples of specific monomers include isobornyl (meth)acrylate, cyclohexyl (meth)acrylate, and dicyclopentanyl (meth)acrylate. These monomers may be used individually, or may be used in combinations of two or more. Among these, from the viewpoint of allowing improvement in durable water repellency of the resulting fiber product, isobornyl (meth)acrylate and cyclohexyl methacrylate are preferable, and isobornyl methacrylate is more preferable.

The mass of the (C2) component for formulation relative to a total of 100 parts by mass of the mass of the (A1) component and the mass of the (Af) component for formulation, from the viewpoint of water repellency, is preferably 3 parts by mass or more, and more preferably 5 parts by mass or more. The mass of the (C2) component for formulation relative to a total of 100 parts by mass of the mass of the (A1) component and the mass of the (Af) component for formulation, from the viewpoint of water repellency, is preferably 30 parts by mass or less, and more preferably 25 parts by mass or less.

The (C3) component above is a methacrylic acid ester monomer having an unsubstituted monovalent chain hydrocarbon group having 1 to 4 carbon atoms directly bonded to the ester bond of the ester moiety. As the chain hydrocarbon group having 1 to 4 carbon atoms, a linear hydrocarbon group having 1 or 2 carbon atoms or a branched hydrocarbon group having 3 or 4 carbon atoms is preferable. Examples of the chain hydrocarbon group having 1 to 4 carbon atoms include a methyl group, an ethyl group, an n-propyl group, an isopropyl group, an n-butyl group, and a t-butyl group. Examples of specific compounds include methyl methacrylate, ethyl methacrylate, n-propyl methacrylate, isopropyl methacrylate, n-butyl methacrylate, isobutyl methacrylate, and t-butyl methacrylate. These monomers may be used individually, or may be used in combinations of two or more. Among these, from the viewpoint of allowing improvement in durable water repellency of the resulting fiber product, methyl methacrylate, isopropyl methacrylate, and t-butyl methacrylate are preferable, and methyl methacrylate is more preferable.

The mass of the (C3) component for formulation relative to a total of 100 parts by mass of the mass of the (A1) component and the mass of the (Af) component for formulation, from the viewpoint of water repellency, is preferably 3 parts by mass or more, and more preferably 5 parts by mass or more. The mass of the (C3) component for formulation relative to a total of 100 parts by mass of the mass of the (A1) component and the mass of the (Af) component for formulation, from the viewpoint of water repellency, is preferably 30 parts by mass or less, and more preferably 25 parts by mass or less.

The (C4) component above is a (meth)acrylic acid ester monomer comprising 3 or more polymerizable unsaturated groups per molecule. The (C4) component is preferably a polyfunctional (meth)acrylic acid ester monomer comprising 3 or more (meth)acryloyloxy groups per molecule, in which T in the general formula (C-4) above is a (meth)acryloyloxy group. In the general formula (C-4), the p number of T may be identical or different. Examples of specific compounds include ethoxylated isocyanuric acid triacrylate, tetramethylolmethane tetraacrylate, tetramethylolmethane tetramethacrylate, trimethylolpropane triacrylate, trimethylolpropane trimethacrylate, pentaerythritol triacrylate, pentaerythritol trimethacrylate, dipentaerythritol hexaacrylate, and dipentaerythritol hexamethacrylate. These monomers may be used individually, or may be used in combinations of two or more. Among these, from the viewpoint of allowing improvement in durable water repellency of the resulting fiber product, tetramethylolmethane tetraacrylate and ethoxylated isocyanuric acid triacrylate are more preferable.

The mass of the (C4) component for formulation relative to a total of 100 parts by mass of the mass of the (A1) component and the mass of the (Af) component for formulation, from the viewpoint of water repellency, is preferably 0.1 parts by mass or more, and more preferably 0.5 parts by mass or more. The mass of the (C4) component for formulation relative to a total of 100 parts by mass of the mass of the (A1) component and the mass of the (Af) component for formulation, from the viewpoint of water repellency, is preferably 10 parts by mass or less, and more preferably 5 parts by mass or less.

The mass of the (C) component for formulation relative to a total of 100 parts by mass of the mass of the (A1) component and the mass of the (Af) component for formulation, from the viewpoint of water repellency, is preferably 0.1 parts by mass or more, and more preferably 0.5 parts by mass or more. The mass of the (C) component for formulation relative to a total of 100 parts by mass of the mass of the (A1) component and the mass of the (Af) component for formulation, from the viewpoint of water repellency, is preferably 30 parts by mass or less, and more preferably 25 parts by mass or less.

### Monomer (VC)

It is preferable that the water-repellent polymer (β), from the viewpoint of peel strength, further comprise a constituent unit derived from a monomer (VC) (also referred to as “(VC) component”) of one or more selected from the group consisting of vinyl chloride and vinylidene chloride.

The (VC) component, from the viewpoint of maintaining texture of a fiber product, is preferably vinyl chloride.

The mass of the (VC) component for formulation relative to a total of 100 parts by mass of the mass of the (A1) component and the mass of the (Af) component for formulation, from the viewpoints of water repellency, durable water repellency, and peel strength, is preferably 10 parts by mass or more, and more preferably 20 parts by mass or more. The mass of the (VC) component for formulation relative to a total of 100 parts by mass of the mass of the (A1) component and the mass of the (Af) component for formulation, from the viewpoints of water repellency, durable water repellency, and texture, is preferably 100 parts by mass or less, and more preferably 75 parts by mass or less.

### Monomer (D)

The water-repellent polymer (β) may further comprise a constituent unit derived from a monofunctional monomer (D) (hereinafter, also referred to as (D) component) copolymerizable with the (A1) component and/or the (Af) component, in a range that does not impair the effect of this disclosure.

Examples of the (D) component include (meth)acryloylmorpholine, (meth)acrylic acid esters having a hydrocarbon group, (meth)acrylic acid, fumaric acid esters, maleic acid esters, fumaric acid, maleic acid, (meth)acrylamide, N-methylolacrylamide, and vinyl-based monomers other than the (VC) component not comprising fluorine, such as vinyl ethers, vinyl esters, ethylene, and styrene. The (meth)acrylic acid ester having a hydrocarbon group may comprise a substituent such as a vinyl group, a hydroxyl group, an amino group, an epoxy group, an isocyanate group, or a blocked isocyanate group on the hydrocarbon group, may comprise a quaternary ammonium group or another substituent other than a group capable of reacting with a crosslinking agent, or may have an ether bond, an ester bond, an amide bond, or a urethane bond. Examples of the (meth)acrylic acid ester include methyl acrylate, 2-ethylhexyl (meth)acrylate, benzyl (meth)acrylate, and ethylene glycol di (meth)acrylate. Among these, from the viewpoint of allowing improvement in peel strength for the coating of the resulting fiber product, (meth)acryloylmorpholine is more preferable.

The weight average molecular weight of the water-repellent polymer (β) is preferably 30,000 or greater. When the weight average molecule weight is 30,000 or greater, the water repellency of the resulting fiber product tends to be further improved. The weight average molecular weight of the water-repellent polymer (β) is more preferably 100,000 or greater. In this instance, the resulting fiber product can exhibit water repellency more sufficient. The upper limit of the weight average molecular weight of the water-repellent polymer (β) is preferably about 5,000,000.

The weight average molecular weight of the water-repellent polymer (β) refers to a value in terms of standard polystyrene, measured by a GPC (gel permeation chromatography) apparatus (for example, GPC “HLC-8020” manufactured by Tosoh Corporation), using tetrahydrofuran as an eluent, under the conditions of column temperature of 40° C. and flow rate of 1.0 ml/min. The column used is a combination of three columns manufactured by Tosoh Corporation, under the trade names TSK-GEL G5000HHR, G4000HHR, and G3000HHR.

The melt viscosity of the water-repellent polymer (β) at 105° C. is preferably 1000 Pa·s or less. When the melt viscosity at 105° C. is 1000 Pa·s or less, a satisfactory texture of the resulting fiber product tends to be easily maintained. When the melt viscosity of the water-repellent polymer (β) is 1000 Pa·s or less, and when the water-repellent polymer (β) is emulsified or dispersed to form a water-repellent agent composition, the water-repellent polymer (β) can be suppressed from precipitating or settling, and thus satisfactory storage stability of the water-repellent agent composition tends to be easily maintained. The melt viscosity at 105° C. is more preferably 500 Pa·s or less. In this instance, the resulting fiber product has superior texture while exhibiting sufficient water repellency. The melt viscosity of the water-repellent polymer (β) at 105° C., for example, may be 10 Pa·s or more, 50 Pa·s or more, or 100 Pa·s or more, from the viewpoint of water repellency.

The “melt viscosity at 105° C.” refers to a viscosity when measured, using an elevated flow tester (for example, CFT-500 manufactured by Shimadzu Corporation), by placing 1 g of the water-repellent polymer (β) in a cylinder mounted with a die (length of 10 mm, diameter of 1 mm), maintaining at 105° C. for 6 min, and applying a load of 100 kg·f/cm2 by a plunger.

### Organic Solvent (γ)

The water-repellent agent composition comprises an organic solvent (γ) in which an amount of water required to dissolve 1 g of the organic solvent at 20° C. is more than 10 mL. The amount of water required to dissolve 1 g of the organic solvent of the above is more than 30 mL in one example, preferably more than 100 mL, and more preferably more than 1000 mL. Such an organic solvent (γ) contributes to the formation of an emulsion dispersion body in which the organo-modified silicone (α) is stably emulsified and dispersed, and therefore contributes to the formation of a water-repellent agent composition having excellent storage stability. The emulsion dispersion or emulsion dispersion body means that in a liquid medium, a liquid exists in an emulsified state and/or a solid exists is a dispersed state. The above amount of water required to dissolve 1 g of the organic solvent is a value measured by the method described in the Examples section in accordance with JIS K8001:2017.

Without being bound by theory, when the organo-modified silicone (α) is emulsified and dispersed in a water-containing medium to form an emulsion dispersion body or a water-repellent agent composition, it is presumed that the organic solvent (γ) contributes to an improvement in emulsion dispersion stability of the organo-modified silicone (α) in the water-containing medium by promoting O/W-type emulsification dispersion of the organo-modified silicone (α).

The organic solvent (γ) preferably has a structure composed of carbon and hydrogen (i.e., a hydrocarbon structure) in a molecule, from the viewpoint of a satisfactory effect of improving emulsion dispersion stability of the organo-modified silicone (α). From such a viewpoint, preferable organic solvents (γ), for example, may be esters (specific examples include 2,2,4-trimethyl-1,3-pentanediol monoisobutyrate, 2,2,4-trimethyl-1,3-pentanediol diisobutyrate, ethyl acetate, butyl acetate, and butyl glycol acetate), ketones (specific examples include methyl isobutyl ketone), ethers (specific examples include dibutyl diglycol, diethylene glycol mono-2-ethylhexyl ether, ethylene glycol monohexyl ether, diethylene glycol monohexyl ether, ethylene glycol mono-2-ethylhexyl ether, dipropylene glycol monopropyl ether, and dipropylene glycol monobutyl ether), alcohols (specific examples include 1-butanol, 1-pentanol, and isooctanol), aromatic solvents (specific examples include toluene, o-xylene, m-xylene, p-xylene, and mesitylene), and petroleum solvents (specifically, synthetic oils such as isoparaffin, mineral oil, mineral spirit, and poly α-olefin). These organic solvents can be used individually or in combinations of two or more.

The number of carbon atoms in isoparaffin is preferably 4 or greater, and more preferable 9 to 20.

Examples of such isoparaffin can include IP Solvent IP-2028 (isoparaffin having 10 to 16 carbon atoms, manufactured by Idemitsu Kodan Co, Ltd.).

Examples of the mineral oil include mineral oils having a kinematic viscosity of 50 mm²/s or less at 30° C., and more specifically include normal undecane, normal dodecane, normal tridecane, normal tetradecane, and paraffin. The kinematic viscosity above is a value measured by a method based on JIS K 2283:2000. The number of carbon atoms in paraffin, for example, may be 10 to 16. The mineral oils may be used individually or in combinations of two or more. In a combination of two or more, it is preferable that the mineral oils are compatible with each other. The mineral oil may be a commercially available product, and can be exemplified by, for example, Cactus Normal Paraffin N-12D, Cactus Normal Paraffin YHNP, and Cactus Normal Paraffin N-14 (the above can be procured from ENEOS Corporation).

Mineral spirits having a boiling point of 130 to 230° C. are particularly preferable.

The amount of organic solvent (γ) in the water-repellent agent composition relative to 100 parts by mass of the organo-modified silicone (α), from the viewpoint of dispersion stability of the organo-modified silicone (α), is preferably 0.5 to 500 parts by mass, more preferably 1 to 400 parts by mass, even more preferably 1 to 300 parts by mass, and particularly preferably 1 to 200 parts by mass. The amount of organic solvent (γ) is preferably within the range above from the viewpoint of satisfactory storage stability and satisfactory water repellency of the water-repellent agent composition.

### Water-Soluble Organic Solvent

The water-repellent agent composition may further comprise a water-soluble organic solvent, in addition to the organic solvent (γ). A water-soluble organic solvent means an organic solvent in which an amount of water required to dissolve 1 g of the organic solvent at 20° C. is 10 mL or less, evaluated by the method described in the Examples section. Examples of the water-soluble organic solvent include dipropylene glycol, tripropylene glycol, butyl diglycol, methyl ethyl ketone, dimethyl formamide, dimethyl sulfoxide, and tetrahydrofuran. Dipropylene glycol, tripropylene glycol, and butyl diglycol are particularly preferable.

### Emulsification Aid or Dispersion Aid

When emulsifying and dispersing the organo-modified silicone (α), one or more selected from nonionic surfactants, cationic surfactants, anionic surfactants, and amphoteric surfactants may be used as an emulsification aid or dispersion aid. The content of the emulsification aid or dispersion aid relative to 100 parts by mass of the organo-modified silicone (α) is preferably 0.5 to 50 parts by mass, more preferably 1 to 40 parts by mass, and even more preferably 1 to 30 parts by mass. When the content of the emulsification aid or dispersion aid is 0.5 parts by mass or more, dispersion stability of the emulsion dispersion body of the organo-modified silicone (α) tends to further improve, and when the content thereof is 50 parts by mass or less, water repellency of the water-repellent agent composition tends to be further improved.

During polymerization or emulsification and dispersion of the water-repellent polymer (β), an emulsification aid or a dispersion aid may be used. The emulsification aid or dispersion aid may be the same as that used when emulsifying and dispersing the organo-modified silicone (α). The content of the emulsification aid or dispersion aid relative to 100 parts by mass of the water-repellent polymer (β) is preferably 0.5 to 50 parts by mass, more preferably 1 to 40 parts by mass, and even more preferably 1 to 30 parts by mass. When the content of the emulsification aid or dispersion aid is 0.5 parts by mass or more, dispersion stability of the emulsion dispersion body of the water-repellent polymer (β) tends to further improve, and when the content thereof is 50 parts by mass or less, water repellency of the water-repellent agent composition tends to be further improved.

### Cationic Surfactant

Examples of the cationic surfactant include monoalkyltrimethylammonium salts having 8 to 24 carbon atoms, dialkyldimethylammonium salts having 8 to 24 carbon atoms, monoalkylamine acetates having 8 to 24 carbon atoms, dialkylamine acetates having 8 to 24 carbon atoms, and alkylimidazoline quaternary salts having 8 to 24 carbon atoms. Among these, from the viewpoint of emulsion properties and processing stability, monoalkyltrimethylammonium salts having 2 to 18 carbon atoms and dialkyldimethylammonium salts having 12 to 18 carbon atoms are preferable. Suitable examples of cationic surfactants include stearyltrimethylammonium sulfate and stearyltrimethylammonium chloride.

These cationic surfactants may be used individually, or may be used in combinations of two or more.

### Nonionic Surfactant

Examples of the nonionic surfactant include alcohols, polycyclic phenols, amines, amides, fatty acids, polyhydric alcohol fatty acid esters, fats and oils, and polypropylene glycol, and alkylene oxide adducts thereof.

Examples of alcohols include linear and branched alcohols and alkenols, each having 8 to 24 carbon atoms; and acetylene alcohols represented by general formula (AL-1):

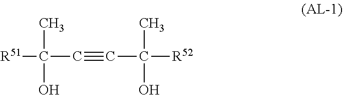

where R⁵¹ and R⁵² each independently represent an alkyl group comprising a linear or branched chain of 1 to 8 carbon atoms or an alkenyl group comprising a linear or branched chain of 2 to 8 carbon atoms, and general formula (AL-2):

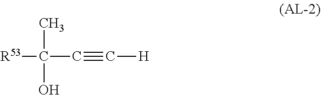

where R⁵³ represents an alkyl group comprising a linear or branched chain of 1 to 8 carbon atoms or an alkenyl group comprising a linear or branched chain of 2 to 8 carbon atoms.

Examples of polycyclic phenols include monohydric phenols such as phenol and naphthol, which may comprise a hydrocarbon group having 1 to 12 carbon atoms, or styrene derivative (for example, styrene, α-methylstyrene, or vinyl toluene) adducts thereof or benzyl chloride reactants thereof. Examples of amines include linear or branched aliphatic amines having 8 to 44 carbon atoms.

Examples of amides include linear and branched fatty acid amides having 8 to 44 carbon atoms.

Examples of fatty acids include linear and branched fatty acids having 8 to 24 carbon atoms.

Examples of polyhydric alcohol fatty acid esters include condensation reaction products of polyhydric alcohols and carboxylic acids having 2 to 30 carbon atoms (including the carbon of the carboxyl group). Examples of such polyhydric alcohol fatty acid esters include sorbitan esters composed of sorbitan (alcohol) and carboxylic acid having 2 to 30 carbon atoms (including the carbon of the carboxyl group).

The number of carbon atoms in carboxylic acid constituting the sorbitan ester is 2 to 30, and preferably 5 to 21. The sorbitan ester may be a monocarboxylic acid ester of sorbitan and one carboxylic acid, a dicarboxylic acid ester of sorbitol and two carboxylic acids, or a tricarboxylic acid ester of sorbitol and three carboxylic acids, and is preferably a monocarboxylic acid ester.

The sorbitan ester may be a compound represented by general formula (4):

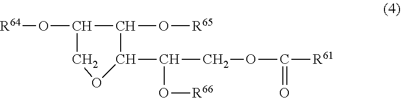

where in formula (4),
R⁶¹ represents an alkyl group having 1 to 22 carbon atoms or an alkenyl group having 2 to 22 carbon atoms, and
R⁶⁴, R⁶⁵, and R⁶⁶ each independently represent a hydrogen atom, —CO—R⁶¹, or —(CH₂CH₂₀)ₑ—(R⁶²O)_{f}—R⁶³ (where R⁶² represents an alkylene group having 3 or more carbon atoms, R⁶³ represents a hydrogen atom, an alkyl group having 1 to 22 carbon atoms, or an alkenyl group having 2 to 22 carbon atoms), e represents an integer of 2 or greater, and f represents an integer of 0 or greater, or general formula (5):

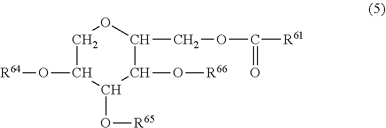

where in formula (5),
R⁶¹ represents an alkyl group having 1 to 22 carbon atoms or an alkenyl group having 2 to 22 carbon atoms, and
R⁶⁴, R⁶⁵, and R⁶⁶ each independently represent a hydrogen atom, —CO—R⁶¹, or —(CH₂CH₂O)ₑ—(R⁶²O)_{f}—R⁶³ (where R⁶² represents an alkylene group having 3 or more carbon atoms, R63 represents a hydrogen atom, an alkyl group having 1 to 22 carbon atoms, or an alkenyl group having 2 to 22 carbon atoms), e represents an integer of 2 or greater, and f represents an integer of 0 or greater.

Examples of compounds represented by the general formula (4) or (5) above include sorbitan monolaurate, sorbitan monostearate, sorbitan monopalmitate, sorbitan monooleate, sorbitan sesquistearate, sorbitan tristearate, polyoxyethylene sorbitan monolaurate, polyoxyethylene sorbitan monopalmitate, polyoxyethylene sorbitan monostearate, polyoxyethylene sorbitan monooleate, and polyoxyethylene sorbitan tristearate.

Examples of oils and fats include plant oils and fats, animal oils and fats, plant waves, animal waxes, mineral waxes, and hydrogenated oils.

From the viewpoint of excellent stability of the organo-modified silicone emulsion dispersion body, a combination of a linear or branched alcohol or alkenol having 8 to 24 carbon atoms and a sorbitan ester is more preferable, and a combination of a polyoxyethylene alkyl ether and a sorbitan fatty acid ester is particularly preferable.

Examples of alkylene oxides include ethylene oxide, 1,2-propylene oxide, 1,2-butylene oxide, 2,3-butylene oxide, 1,4-butylene oxide, styrene oxide, and epichlorohydrin. From the viewpoints of having little effect on water repellency and improving emulsion properties of the organo-modified silicone (α) or the water-repellent polymer (β), the alkylene oxide is preferably ethylene oxide or 1,2-propylene oxide, and more preferably ethylene oxide.

The number of moles of alkylene oxide added is preferably 1 to 200, more preferably 3 to 100, or even more preferably 5 to 50. When the number of moles of alkylene oxide added is within the range above, water repellency and product stability at high levels are more easily obtained.

The HLB of the nonionic surfactant is preferably 2 to 18, and more preferably 2 to 16. From the viewpoint of storage stability of the water-repellent agent composition, it is more preferable that two or more nonionic surfactants having different HLBs with the range above be used. When using a nonionic surfactant for emulsifying and dispersing the organo-modified silicone (α), it is preferable from the viewpoint of obtaining satisfactory emulsification and dispersion properties that the HLB be within the range above. When using a nonionic surfactant for emulsifying and dispersing the water-repellent polymer (β), it is preferable from the viewpoint of forming a satisfactory aqueous dispersion liquid, the HLB is preferably 7 to 18, and further, in consideration of emulsion stability during emulsion polymerization or dispersion polymerization and in the composition after polymerization, the HLB is more preferably 9 to 15.

From the viewpoint of obtaining satisfactory emulsion stability and water repellency of the water-repellent agent composition, it is more preferable that a cationic surfactant and a nonionic surfactant be used in combination.

### Additional Components

The water-repellent agent composition may comprise an additional water-repellent component. Examples of the additional water-repellent component include waxes such as paraffin wax, microcrystalline wax, Fischer-Tropsch wax, and polyethylene wax; and animal, plant, and mineral waxes. In addition, various additives such as an initiator and a chain transfer agent may be used as desired.

### Manufacturing Method for Water-Repellent Agent Composition

The water-repellent agent composition can be manufactured by, for example,
(1) a method comprising a mixing step of mixing an emulsion dispersion body comprising an organo-modified silicone (α) and an organic solvent (γ) (hereinafter, also referred to as an organo-modified silicone (α) emulsion dispersion body) and an emulsion dispersion body comprising a water-repellent polymer (β) (hereinafter, also referred to as a water-repellent polymer (β) emulsion dispersion body),
(2) a method comprising a mixing step of mixing an emulsion dispersion body comprising an organo-modified silicone (α) and an organic solvent (γ) and a monomer component that is a raw material of a water-repellent polymer (β); and a polymerization step of polymerizing the monomer component above after the mixing step and/or during the mixing step to generate a water-repellent polymer (β), or
(3) a method comprising a mixing step of mixing an organo-modified silicone (α), a monomer component that is a raw material of a water-repellent polymer (β), and an organic solvent (γ); and a polymerization step of polymerizing the monomer component above after the mixing step and/or during the mixing step to generate a water-repellent polymer (β).

In the method of (1) or (2) above, the organo-modified silicone (α) emulsion dispersion body comprises an organic solvent (γ) as a medium and optionally an additional medium, and can be prepared by mixing the organo-modified silicone (α), the organic solvent (γ), and as needed, an optional component of one or more of the emulsification aid and an additional medium, and emulsifying and dispersing the mixture. The method of emulsion dispersion may be mixing by stirring, ultrasonic mixing, or a combination thereof. As the additional medium above, water, the water-soluble organic solvent, or a combination thereof can be exemplified. The amount of organo-modified silicone (α) in the organo-modified silicone (α) emulsion dispersion body is preferably 1 to 80% by mass, more preferably 2 to 70% by mass, and even more preferably 5 to 60% by mass.

In the method of (1) above, the water-repellent polymer (β) emulsion dispersion body may be a polymerization liquid obtained when the water-repellent polymer (β) is manufactured by emulsion polymerization or dispersion polymerization, or may be one obtained by emulsifying and dispersing a pre-synthesized water-repellent polymer (β) in a suitable medium. The medium may be water, the water-soluble organic solvent, or a combination thereof. The medium may comprise water and a water-soluble organic solvent, for example, in a mass ratio of 100/0 to 20/80 or 98/2 to 30/70.

The amount of water-repellent polymer (β) in the water-repellent polymer (β) emulsion dispersion body is preferably 1 to 80% by mass, more preferably 2 to 70% by mass, and even more preferably 5 to 60% by mass.

As mixing conditions in the mixing step of methods (1) to (3) above, conditions of 100 rpm×10 min with a stirrer can be exemplified.

In the method of (2) or (3) above, polymerization conditions for the monomer component that is a raw material of the water-repellent polymer (β) may be set as desired, and for example, may be a temperature of 60 to 75° C. and a time of 4 to 8 h.

The water-repellent agent composition obtained above may be further subjected to a dispersion treatment such as a high-pressure homogenization treatment. Such a dispersion treatment is particularly useful in a method of preparing a water-repellent agent composition using a preliminarily prepared emulsion dispersion body, i.e., the method of (1) or (2) above.

### Water-Repellent Aid

One aspect also provides a water-repellent aid for an acrylic water-repellent agent, comprising the organo-modified silicone (α) and the organic solvent (γ). In one aspect, the acrylic water-repellent agent is the water-repellent polymer (β) described above, but another acrylic water-repellent agent is also applicable. Therefore, one aspect also provides a water-repellent agent composition comprising the water-repellent aid and another acrylic water-repellent agent above. The water-repellent aid can form a water-repellent agent composition having excellent water repellency, durable water repellency, and storage stability. In one aspect, the water-repellent aid is an emulsion dispersion body of the organo-modified silicone (α) as described above.

### Water-Repellent Fiber Product and Manufacturing Method Therefor

One aspect provides a water-repellent fiber product comprising a fiber product and the water-repellent agent composition deposited on the fiber product.

Another aspect provides a manufacturing method for the water-repellent fiber product, comprising a step of treating a fiber product with a treatment liquid comprising the water-repellent agent composition.

The treatment liquid may be the water-repellent agent composition itself, or the water-repellent agent composition diluted with a medium such as water. In one aspect, the treatment liquid may comprise the organo-modified silicone (α) and the acrylic water-repellent agent (the water-repellent polymer (β) in one aspect) in a total of, for example, 0.5 to 70% by mass, 1 to 50% by mass, or 1.5 to 45% by mass. The treatment liquid may preliminarily comprise the crosslinking agent described below in an amount of, for example, 0.1 to 5.0% by mass, 0).2 to 3.0% by mass, or 0.3 to 2.0% by mass.

The water-repellent fiber product is obtained by treating fibers with a treatment liquid comprising the water-repellent agent composition, thereby depositing the organo-modified silicone (α) and the acrylic water-repellent agent (the water-repellent polymer (β) in one aspect) on the fibers. The material of the fibers is not particularly limited, and includes natural fibers such as cotton, hemp, silk, and wool; semi-synthetic fibers such as rayon and acetate; synthetic fibers such as nylon, polyester, polyurethane, and polypropylene; and composite fibers and blended fibers thereof. The form of the fiber product may be any form such as fiber, yarn, fabric, nonwoven fabric, or paper.

Examples of methods of treating a fiber product with the treatment liquid above include processing methods such as immersion, spraying, and coating. When the water-repellent agent composition contains water, it is preferable that the treatment liquid be dried to remove water after deposition thereof on the fiber product.

The deposition amount of the water-repellent agent composition on the fiber product can be appropriately adjusted according to the required degree of water repellency, but from the viewpoints of water repellency and texture, is preferably adjusted so that the deposition amount of a total of the organo-modified silicone (α) and the acrylic water-repellent agent (the water-repellent polymer (β) in one aspect) contained in the water-repellent agent composition is 0.01 to 10 g relative to 100 g of the fiber product, and more preferably adjusted so that the deposition amount is 0.05 to 5 g. The deposition amount is confirmed by, for example, a method of solvent extraction from the water-repellent fiber product.

After the organo-modified silicone (α) and the acrylic water-repellent agent (the water-repellent polymer (β) in one aspect) are deposited on the fiber product, it is preferable that the fiber product be appropriately heat-treated. The temperature condition is not particularly limited, but when using the water-repellent agent composition. sufficiently satisfactory water repellency can be exhibited in the fiber product under mild conditions of 100 to 130° C. The temperature condition may be a high-temperature treatment at 130° C. or higher (preferably up to 200° C.). However, it is possible to shorten the treatment time compared to the prior art where a fluorine-based water-repellent agent is used. Therefore, according to the water-repellent fiber product, deterioration of the fiber product due to heat is suppressed, texture of the fiber product is soft after water-repellent treatment, and water repellency can be sufficiently imparted to the fiber product under mild heat treatment conditions, i.e., low-temperature curing conditions.

Particularly, when an improvement in durable water repellency is desired, it is preferable that the fiber product be subjected to a water-repellent processing by a method comprising the above step of treating the fiber product with a treatment liquid comprising the water-repellent agent composition and a step of depositing a crosslinking agent typified by a melamine resin, a glyoxal resin, and a compound comprising one or more isocyanate groups or blocked isocyanate groups on the fiber product, followed by heating. When a further improvement in durable water repellency is desired, it is preferable that the water-repellent agent composition comprise a water-repellent polymer (β) obtained by copolymerizing a monomer comprising a functional group capable of reacting with the above crosslinking agent.

As the melamine resin, compounds having a melamine skeleton can be used. Examples include polymethylolmelamines such as trimethylolmelamine and hexamethylolmelamine; alkoxymethylmelamines in which a portion or all of the methylol groups of polymethylolmelamine are alkoxymethyl groups comprising an alkyl group having 1 to 6 carbon atoms; and acyloxymethylmelamines in which a portion or all of the methylol groups of polymethylolmelamine are acyloxymethyl groups comprising an acyl group having 2 to 6 carbon atoms. These melamine resins may be monomers or multimers of dimers or higher, or mixtures thereof. Further, resins in which melamine is partially co-condensed with urea can be used. Examples of such melamine resins include Beckamine APM, Beckamine M-3, Beckamine M-3 (60), Beckamine MA-S, Beckamine J-101, and Beckamine J-101LF manufactured by DIC Corporation; Unika Resin 380K manufactured by Union Chemical Industry Co., Ltd.; and Riken Resin MM series manufactured by Mikiriken Industrial Co., Ltd.

As the glyoxal resin, conventionally known glyoxal resins can be used. Examples of the glyoxal resin include 1,3-dimethylglyoxal urea resin, dimethylol dihydroxyethylene urea resin, and dimethylol dihydroxypropylene urea resin. The functional groups of these resins may be substituted with other functional groups. Examples of such glyoxal resins include Beckamine N-80, Beckamine NS-11, Beckamine LF-K, Beckamine NS-19, Beckamine LF-55P Conc, Beckamine NS-210L, Beckamine NS-200, and Beckamine NF-3 manufactured by DIC Corporation; Uni Resin GS-20E manufactured by Union Chemical Industry Co., Ltd.; and Riken Resin RG series and Riken Resin MS series manufactured by Mikiriken Industrial Co., Ltd.

It is preferable that a catalyst be used in the melamine resins and glyoxal resins from the viewpoint of promoting a reaction. Such a catalyst is not particularly limited as long as the catalyst is a commonly used one. Examples include fluoroborate compounds such as ammonium fluoroborate and zinc fluoroborate; neutral metal salt catalysts such as magnesium chloride and magnesium sulfate; and inorganic acids such as phosphoric acid, hydrochloric acid, and boric acid. An organic acid such as citric acid, tartaric acid, malic acid, maleic acid, or lactic acid can be used in combination with any of the above catalysts as a cocatalyst. Examples of such catalysts include Catalyst ACX, Catalyst 376, Catalyst O, Catalyst M, Catalyst G (GT), Catalyst X-110, Catalyst GT-3, and Catalyst NFC-1 manufactured by DIC Corporation; Unika Catalyst 3-P and Unika Catalyst MC-109 manufactured by Union Chemical Industry Co., Ltd.; and Riken Fixer RC series, Riken Fixer MX series, and Riken Fixer RZ-5 manufactured by Mikiriken Industrial Co., Ltd.

As the compound comprising one or more isocyanate groups or blocked isocyanate groups, monofunctional (mono)isocyanate compounds such as butyl isocyanate, phenyl isocyanate, tolyl isocyanate, and naphthalene isocyanate; and polyfunctional isocyanate compounds can be used.

The polyfunctional isocyanate compound is not particularly limited as long as the compound comprises two or more isocyanate groups per molecule. Any known polyisocyanate compound can be used. Examples of the polyfunctional isocyanate compound include diisocyanate compounds such as alkylene diisocyanate, aryl diisocyanate, and cycloalkyl diisocyanate; and modified polyisocyanate compounds such as dimers and trimers of these diisocyanate compounds. The number of carbon atoms in alkylene diisocyanate is preferably 1 to 12.

Examples of diisocyanate compounds include 2,4- or 2,6-tolylene diisocyanate, ethylene diisocyanate, propylene diisocyanate, 4,4-diphenylmethane diisocyanate, p-phenylene diisocyanate, tetramethylene diisocyanate, hexamethylene diisocyanate, decamethylene diisocyanate, dodecamethylene diisocyanate, 2,4,4-trimethylhexamethylene-1,6-diisocyanate, phenylene diisocyanate, tolylene or naphthylene diisocyanate, 4,4′-methylene-bis(phenylisocyanate), 2,4′-methylene-bis(phenylisocyanate) , 3,4′-methylene-bis(phenylisocyanate), 4,4′-ethylene-bis(phenylisocyanate), ω,ω′-diisocyanate-1,3-dimethylbenzene, ω,ω′-diisocyanate-1,4-dimethylcyclohexane, ω,ω′-diisocyanate-1,4-dimethylbenzene, ω,ω′-diisocyanate-1,3-dimethylcyclohexane, 1-methyl-2,4-diisocyanate cyclohexane, 4,4′-methylene-bis(cyclohexyl isocyanate), 3-isocyanate-methyl-3,5,5-trimethylcyclohexyl isocyanate, acid-diisocyanate dimer, ω,ω′-diisocyanate diethylbenzene, ω,ω′-diisocyanate dimethyltoluene, ω,ω′-diisocyanate diethyltoluene, fumaric acid bis(2-isocyanate ethyl) ester, 1,4-bis(2-isocyanate-prop-2-yl)benzene, and 1,3-bis(2-isocyanate-prop-2-yl)benzene.

Examples of triisocyanate compounds include triphenylmethane triisocyanate, dimethyl triphenylmethane tetraisocyanate, and tris(isocyanatophenyl)-thiophosphate.

The modified polyisocyanate compound derived from a diisocyanate compound is not particularly limited as long as the compound has two or more isocyanate groups. Examples includes polyisocyanates having a biuret structure, an isocyanurate structure, a urethane structure, a uretdione structure, an allophanate structure, and a trimer structure; and adducts of aliphatic isocyanates of trimethylolpropane. Polymeric MDI (MDI=diphenylmethane diisocyanate) can also be used as a polyfunctional isocyanate compound.

The polyfunctional isocyanate compounds can be used individually or in combinations of two or more.

The isocyanate group included in the poly functional isocyanate compound may be as-is, or may be a blocked isocyanate group blocked by a blocking agent. Examples of the blocking agent include pyrazoles such as 3,5-dimethylpyrazole, 3-methylpyrazole, 3,5-dimethyl-4-nitropyrazole, 3,5-dimethyl-4-bromopyrazole, and pyrazole; phenols such as phenol, methylphenol, chlorophenol, iso-butylphenol, tert-butylphenol, iso-amylphenol, octylphenol, and nonylphenol; lactams such as ε-caprolactam, δ-valerolactam, and γ-butyrolactam; active methylene compounds such as dimethyl malonate, diethyl malonate, acetylacetone, methyl acetoacetate, and ethyl acetoacetate; oximes such as formaldoxime, acetaldoxime, acetone oxime, methyl ethyl ketone oxime, cyclohexanone oxime, acetophenone oxime, and benzophenone oxime; imidazole compounds such as imidazole and 2-methylimidazole; and sodium bisulfite. Among these, from the viewpoint of water repellency, pyrazoles and oximes are preferable.

As the polyfunctional isocyanate compound, water-dispersible isocyanates, which are obtained by imparting water dispersibility to polyisocyanate by introducing a hydrophilic group into the polyisocyanate structure to impart a surfactant effect, can be used. To promote the reaction, known catalysts such as organotin and organozinc can be used in combination therewith.

The crosslinking agents and the catalysts can each be used individually or in combinations of two or more.

The crosslinking agent can be deposited on an object to be treated by, for example, a method of immersing the object to be treated (fiber product) in a treatment liquid obtained by dissolving the crosslinking agent in an organic solvent or emulsifying and dispersing the crosslinking agent in water and drying the treatment liquid deposited on the object to be treated. By heating the crosslinking agent deposited on the object to be treated, a reaction of the crosslinking agent with the object to be treated and the water-repellent polymer (β) can proceed. To sufficiently advance the reaction of the crosslinking agent and more effectively improve washing durability, heating at this time may be carried out at 110 to 180° C. for 1 to 5 min. The steps of depositing and heating the crosslinking agent may be carried out simultaneously with the step of treating with the treatment liquid comprising the above water-repellent agent composition. When carried out simultaneously, for example, the treatment liquid containing the water-repellent agent composition and the crosslinking agent is deposited on the object to be treated, water is removed, and then the crosslinking agent deposited on the object to be treated is heated. It is preferable that the steps of depositing and heating the crosslinking agent be carried out simultaneously with the step of treating with the water-repellent agent composition when considering the simplification of the water-repellent processing step, reduction of the amount of heat, and economic efficiency.

When a crosslinking agent is excessively used, there is a risk of impairing the texture. The crosslinking agent above relative to the treatment object to be treated (fiber product) is preferably used in an amount of 0.1 to 50% by mass, and particularly preferably in an amount of 0.1 to 10% by mass.

The water-repellent fiber product obtained as such can exhibit sufficient water repellency even when used outdoors for a long period of time. In addition, the water-repellent fiber product above can be made environmentally friendly if no fluorine-based compound is used.

The water-repellent fiber product can be subjected to coating processing at a predetermined portion thereof. Examples of the coating processing include moisture-permeable waterproofing and wind proofing for sports and outdoor uses. Processing can be carried out by, for example, in moisture-permeable waterproofing, applying a coating liquid comprising a urethane resin or an acrylic resin and a medium to one side of a fiber product treated for water repellency and drying, as a processing method.

From the above, the preferred examples of this disclosure have been described. However, this disclosure is not limited to the examples above.

For example, when manufacturing the water-repellent polymer (β) contained in the water-repellent agent composition, the polymerization reaction may be carried out by radical polymerization. However, the polymerization reaction may also be carried out by photopolymerization emitting ionizing radiation such ultraviolet rays, electron beams, and γ rays.

A fiber product is treated with the water-repellent agent composition to obtain a water-repellent fiber product. However, the product to be treated with the water-repellent agent composition is not limited to fiber product applications, and may be an article of metal, glass, or resin. In such instance, the method of depositing the water-repellent agent composition on the article and the deposition amount of the water-repellent agent can be arbitrarily determined according to the product to be treated.

### EXAMPLES

Hereinafter, our methods will be further described by way of the Examples. However, this disclosure is not limited to these Examples.

### Synthesis Example of Organo-Modified Silicone

### Synthesis Example 1

Methyl hydrogen silicone having a SiH:SiCH₃ molar ratio of 9:1 (as measured by ¹H NMR (nuclear magnetic resonance)) and, as a hydrosilylation catalyst, a mixed solution of platinum(IV) chloride in ethylene glycol monobutyl ether and toluene were charged in a flask so that platinum concentration was 5 ppm relative to the reactants in the system. The inside of the flask was purged with nitrogen, and 1 molar equivalent of 1-octadecene per molar equivalent of the reactive group (Si—H) of methyl hydrogen silicone was added dropwise to the mixture in the flask. The inside of a pot was heated to 120° C. and an addition reaction was carried out for 6 h to obtain an organo-modified silicone corresponding to R²⁰, R²¹, and R²²=CH₃, R²³=C18H₃₇, a=5, b=45, a:b=1:9, and R³⁰ to R³⁵=CH₃ in the formula (1). Completion of the addition reaction was confirmed by FT-IR (Fourier transform infrared) spectroscopic analysis of the obtained organo-modified silicone, which was carried out by confirming that the absorption spectrum derived from the SiH group of the methyl hydrogen silicone had disappeared.

### Synthesis Examples 2 to 8 and Comparative Synthesis Example 1

Except that the formulations were changed as indicated in Table 1, organo-modified silicones corresponding to the following in the formula (1) were obtained in the same manner as in Synthesis Example 1.

Synthesis Example 2: R²⁰, R²¹, and R²²=CH₃, R²³=C₁₈H₃₇, a=20, b=30, a:b=4:6, and R³⁰ to R³⁵=CH₃

Synthesis Example 3: R²⁰, R²¹, and R²²=CH₃, R²³=C₁₈H₃₇, a=25, b=25, a:b=5:5, and R³⁰ to R³⁵=CH₃

Synthesis Example 4: R²⁰, R²¹, and R²²=CH₃, R²³=C₁₈H₃₇, a=35, b=15, a:b=7:3, and R³⁰ to R³⁵=CH₃

Synthesis Example 5: R²⁰, R²¹, and R²²=CH₃, R²³=C₈H₁₇, a=25, b=25, a:b=5:5, and R³⁰ to R³⁵=CH₃

Synthesis Example 6: R²⁰, R²¹, and R²²=CH₃, R²³=C₂₂H₄₅, a=25, b=25, a:b=5:5, and R³⁰ to R³⁵=CH₃

Synthesis Example 7: R²⁰, R²¹, and R²²=CH₃, R²³=C₂₆H₅₃, a=25, b=25, a:b=5:5, and R³⁰ to R³⁵=CH₃

Synthesis Example 8: R²⁰, R²¹, and R²²=CH₃, R²³=C₃₂H₆₅, a=25, b=25, a:b=5:5, and R³⁰ to R³⁵=CH₃

Comparative Synthesis Example 1: R²⁰, R²¹, and R²²=CH₃, R²³=C₃H₇, a=25, b=25, a:b=5:5, and R³⁰ to R³⁵=CH₃

### Preparation Example of Organo-Modified Silicone Emulsion Dispersion Body

### Preparation Example α1

30 g of organo-modified silicone obtained in Synthesis Example 1, 30 g of IP Solvent IP-2028 (isoparaffin having 10 to 16 carbon atoms), 3 g of sorbitan fatty acid ester (HLB of 7 or less), 4.5 g of polyoxyethylene alkyl ether (HLB of 8 to 14), and 0.75 g of alkyl (C16-18) trimethyl ammonium chloride were charged in a 300-ml plastic container and mixed until uniform. After uniformity was reached, 31.75 of pure water was added, and the mixture was emulsified and dispersed by ultrasonic waves for 10 min to obtain an organo-modified silicone emulsion dispersion body having an organo-modified silicone content ratio of 30% by mass.

### Preparation Examples α2 to α15 and Comparative Preparation Examples α1 to α4

In accordance with the formulations indicated in Table 2, organo-modified silicone emulsion dispersion bodies were obtained by the same procedure as in Preparation Example α1.

For the organic solvent used in each Preparation Example, the amount of water required to dissolve 1 g of the organic solvent, in accordance with JIS K8001:2017, 3.2 “Terms expressing degree of dissolution”, was evaluated as the volume (mL) of water required to dissolve 1 g of the organic solvent added into a fixed amount of water within 30 min when shaken vigorously for 30 s every 5 min at 20° C.±5° C. In this measurement, 1 mL, 10 mL, 30 mL, 100 mL, and 1000 mL of water were used, and whether 1 g of the organic solvent dissolved within 30 min under the conditions above was examined. The evaluation criteria were as follows.

Evaluation criteria of amount of water required to dissolve 1 g of organic solvent
1 mL or less: dissolved in 1 mL of water within 30 min
More than 1 mL and 10 mL or less: did not dissolve in 1 mL of water within 30 min, but dissolved in 10 mL of water within 30 min
More than 10 mL and 30 mL or less: did not dissolve in 10 mL of water within 30 min, but dissolved in 30 mL of water within 30 min
More than 30 mL and 100 mL or less: did not dissolve in 30 mL of water within 30 min, but dissolved in 100 mL of water within 30 min
More than 100 mL and 1000 mL or less: did not dissolve in 100 ml of water within 30 min, but dissolved in 1000 mL of water within 30 min
More than 1000 mL: did not dissolve in 1000 mL of water within 30 min
Amount of water required to dissolve 1 g of organic solvent
Isoparaffin (isoparaffin having 10 to 16 carbon atoms): more than 1000 mL
Mineral oil (kinematic viscosity at 30° C.: 20 mm²/s): more than 1000 ml
Mineral spirit (boiling point: 180 to 200° C.): more than 1000 mL
Ester (2,2,4-trimethyl-1,3-pentanediol diisobutyrate): more than 1000 mL
Tripropylene glycol (TPG): 1 mL or less
Dipropylene glycol (DPG): 1 mL or less
Butyl diglycol: 1 mL or less

### Preparation Example of Water-Repellent Polymer Dispersion Body

### Preparation Example β1

24.0 g of stearyl acrylate, 0.2 g of Noigen XL-100 (manufactured by Daiichi Kogyo Seiyaku Co. Ltd., polyoxyalkylene branched decyl ether, HLB=14.7), 1.3 g of Noigen XL-60 (manufactured by Daiichi Kogyo Seiyaku Co. Ltd., polyoxyalkylene branched decyl ether, HLB=12.5), 0.5 g of Noigen XL-40 (manufactured by Daiichi Kogyo Seiyaku Co. Ltd., polyoxyalkylene branched decyl ether, HLB=10.5), 0.4 g of alkyl (C16-18) trimethyl ammonium chloride, 12.5 g of tripropylene glycol, and 54.8 of water were charged in an autoclave and mixed by stirring at 45° C. into a mixed liquid. The mixed liquid was irradiated with ultrasonic waves to emulsify and disperse all monomers. 0.2 g of azobis(isobutylamidine) dihydrochloride and 0.08 g of dodecyl mercaptan were then added to the mixed liquid, and the mixture was subjected to radical polymerization with 6.0 g of vinyl chloride at 60° C. for 6 h in a nitrogen atmosphere while continuously pressurizing the autoclave so that the internal pressure was maintained at 0.3 MPa to obtain a water-repellent polymer emulsion dispersion body comprising 30.0% by mass of a water-repellent polymer (β).

### Preparation Example β2

Except that vinyl chloride was changed to vinylidene chloride, a water-repellent polymer emulsion dispersion body comprising 30.0% by mass of a water-repellent polymer (β) was obtained by the same procedure as in Preparation Example β1.

### Preparation Example β3

28.5 g of stearyl acrylate, 0.75 g of Latemul PD-420, 0.75 g of Latemul PD-430, 0.2 g of Noigen XL-100 (manufactured by Daiichi Kogyo Seiyaku Co. Ltd., polyoxyalkylene branched decyl ether, HLB=14.7), 1.3 g of Noigen XL-60 (manufactured by Daiichi Kogyo Seiyaku Co. Ltd., polyoxyalkylene branched decyl ether, HLB=12.5), 0.5 g of Noigen XL-40 (manufactured by Daiichi Kogyo Seiyaku Co. Ltd., polyoxyalkylene branched decyl ether, HLB=10.5), 0.4 g of alkyl (C16-18) trimethyl ammonium chloride, 12.5 g of tripropylene glycol, and 54.8 g of water were charged in an autoclave and mixed by stirring at 45° C. into a mixed liquid. The mixed liquid was irradiated with ultrasonic waves to emulsify and disperse all monomers. 0.2 g of azobis(isobutylamidine) dihydrochloride and 0.08 g of dodecyl mercaptan were then added to the mixed liquid, and the mixture was subjected to radical polymerization at 60° C. for 6 h in a nitrogen atmosphere to obtain a water-repellent polymer emulsion dispersion body comprising 30.0% by mass of a water-repellent polymer (β).

### Preparation Example β4

Except that the amount of stearyl acrylate was changed from 28.5 g to 30.0 g, and Latemul PD-420 and Latemul PD-430 were not used, a water-repellent polymer emulsion dispersion body comprising 30.0% by mass of a water-repellent polymer (β) was obtained by the same procedure as in Preparation Example β3.

### Preparation Example β5

Except that the amount of stearyl acrylate was changed from 30.0 g to 15.0 g, and 15.0 on of C6SFMA (CF₃CH₂—(CF₂CF₂)₂—CH₂CH₂OCOC(CH₃)═CH₂ (2-(perfluorohexyl)ethyl methacrylate) was used, a water-repellent polymer emulsion dispersion body comprising 30.0% by mass of a water-repellent polymer (β) was obtained by the same procedure as in Preparation Example β4.

### Preparation Example β6

Except that C6SFMA was changed to C6SFCLA (CF₃CF₂—(CF₂CF₂)₂—CH₂CH₂OCOC(Cl)═CH₂ (2-(perfluorohexyl)ethyl chloroacrylate), a water-repellent polymer emulsion dispersion body comprising 30.0% by mass of a water-repellent polymer (β) was obtained by the same procedure as in Preparation Example β5.

### Preparation Example β7

Except that stearyl acrylate was changed to lauryl acrylate, a water-repellent polymer emulsion dispersion body comprising 30.0% by mass of a water-repellent polymer (β) was obtained by the same procedure as in Preparation Example β4.

### Preparation Example β8

Except that stearyl acrylate was changed to behenyl acrylate, a water-repellent polymer emulsion dispersion body comprising 30.0% by mass of a water-repellent polymer (β) was obtained by the same procedure as in Preparation Example β4.

### Preparation Example β9

Except that the amount of stearyl acrylate was changed from 30.0 g to 24.0 g, and 6.0 g of stearyl methacrylate was used, a water-repellent polymer emulsion dispersion body comprising 30.0% by mass of a water-repellent polymer (β) was obtained by the same procedure as in Preparation Example β4.

### Preparation Example β10

Except that the amount of stearyl acrylate was changed from 28.5 g to 29.4 g, and 0.75 g of Latemul PD-420 and 0.75 g of Latemul PD-430 were changed to 0.6 g of diacetone acrylamide, a water-repellent polymer emulsion dispersion body comprising 30.0% by mass of a water-repellent polymer (β) was obtained by the same procedure as in Preparation Example β3.

### Preparation Example β11

Except that in the preparation of the mixed liquid, the amount of stearyl acrylate was changed from 24.0 g to 23.4 g and 0.6 g of diacetone acrylamide was further stirred and mixed therein, a water-repellent polymer emulsion dispersion body comprising 30.0% by mass of a water-repellent polymer (β) was obtained by the same procedure as in Preparation Example β1.

### Comparative Preparation Example β1

Except that stearyl acrylate was changed to decyl acrylate, a water-repellent polymer emulsion dispersion body comprising 30.0% by mass of a water-repellent polymer (β) was obtained by the same procedure as in Preparation Example β4.

### Manufacture and Evaluation of Water-Repellent Agent Composition and Fiber Product

### Example A1

80 g of the water-repellent polymer emulsion dispersion body obtained in Preparation Example β4 and 20 g of the organo-modified silicone emulsion dispersion body obtained in Preparation Example β3 were mixed with a stirrer under the condition of 100 rpm×10 min to obtain a water-repellent agent composition.

### Example A2

24 g of stearyl acrylate, 0.25 g of alkyl (C16-18) trimethyl ammonium chloride as a cationic surfactant, 1.1 g of polyoxyethylene alkyl ether (HLB of 8 to 14), and 10 g of tripropylene glycol were added into 44.4 g of pure water and mixed by stirring to obtain a mixed liquid. 20 g of the organo-modified silicone emulsion dispersion body obtained in Preparation Example α3 was added to the mixed liquid and further stirred, 0.06 g of dodecyl mercaptan and 0.2 g of azobis(isobutylamidine) dihydrochloride were added thereto, and the mixture was subjected to a polymerization reaction at 65° C. for 5 h to obtain a water-repellent agent composition.

### Example A3

A mixture obtained by mixing 80 g of the water-repellent polymer emulsion dispersion body obtained in Preparation Example β4 and 20 g of the organo-modified silicone emulsion dispersion body obtained in Preparation Example α3 was subjected to a high-pressure homogenization treatment at 50 to 60° C. at a treatment pressure of 300 kg/cm² using a high-pressure homogenizer (model number 15MR-8TA manufactured by APV Gaulin) to obtain a water-repellent agent composition.

### Example A4

24 g of stearyl acrylate, 0.25 g of alkyl (C16-18) trimethyl ammonium chloride as a cationic surfactant, 1.1 g of polyoxyethylene alkyl ether (HLB of 8 to 14), 6.0 g of the organo-modified silicone obtained in Synthesis Example 3, and 20 g of isoparaffin were added and mixed by stirring to obtain a uniform mixed liquid. 48.4 g of pure water was added into the mixed liquid, and the mixture was irradiated with ultrasonic waves at 40 to 50° C. for 5 min (ϕ 36, oscillating amplitude value of 80%) using an ultrasonic treatment apparatus (model number US-600E manufactured by NISSEI Corporation) to obtain an emulsion dispersion body. 0.06 g of dodecyl mercaptan and 0.2 g of azobis(isobutylamidine) dihydrochloride were added to the emulsion dispersion body, and the mixture was subjected to a polymerization reaction at 65° C. for 5 h to obtain a water-repellent agent composition.

### Comparative Example A1

18.75 g of the organo-modified silicone obtained in Synthesis Example 6, 11.25 g of stearyl acrylate, 2.0 g of polyoxyethylene alkyl ether (HLB of 8 to 14), 0.4 g of alkyl (C16-18) trimethyl ammonium chloride as a cationic surfactant, and 12.5 g of tripropylene glycol were added into 55 g of pure water and mixed by stirring. 0.03 g of lauryl mercaptan and 0. 1 g of azobis(isobutylamidine) dihydrochloride were further added, and the mixture was subjected to a polymerization reaction at 65° C. for 5 h to obtain a water-repellent agent composition.

### Comparative Example A2

11.58 g of behenyl methacrylate, 11.58 g of stearyl methacrylate, 0.54 g of 2-hydroxyethyl methacrylate, 6.3 g of Silwax D222, 2.0 g of polyoxyethylene alkyl ether (HLB of 8 to 14), 0.4 g of alkyl (C16-18) trimethyl ammonium chloride as a cationic surfactant, and 12.5 g of dipropylene glycol were added and mixed by stirring to obtain a mixed liquid. The mixed liquid was subjected to high-pressure dispersion at a temperature of 50 to 60° C. at a treatment pressure of 300 kg/cm² using the above high-pressure homogenizer. 0.2 g of initiator V-50 was further added, and the mixture was subjected to a polymerization reaction at 65° C. for 8 h to obtain a water-repellent agent composition for comparison.

For each of the obtained water-repellent agent compositions, production of treatment fabrics and evaluation of initial water repellency, durable water repellency, and storage stability were carried out by the methods described below.

### Examples B1 to B31, Reference Example B1, and Comparative Examples B1 to B8

The water-repellent polymer dispersion body and the organo-modified silicone dispersion body, and in some instances, the above additional water-repellent component dispersion body were mixed in the formulations (parts by mass) shown in Tables 5 and 6 to obtain a water-repellent agent composition. Mixing was carried out with a stirrer under the condition of 100 rpm × 10 min. The additional water-repellent component dispersion body was prepared by the following method.

### Preparation of Additional Water-Repellent Component Dispersion Body

30 g of paraffin wax having a melting point of 155° F., 1.5 g of sorbitan monopalmitate, 3.0 g of polyoxyethylene alkyl ether (HLB of 8 to 14), 0.75 g of alkyl (C16-18) trimethyl ammonium chloride as a cationic emulsifier, and 64.75 g of pure water were charged in a 300-ml high-pressure reaction vessel and sealed, heated to 100° C. while stirring, and subjected to high-pressure emulsification under high pressure for 30 min to obtain a wax dispersion liquid as an additional water-repellent component dispersion body.

### Manufacture of Water-Repellent Fiber Product

The following were used as the treatment fabrics.
Polyester (PET)/Polyurethane (PU) blended fabric (polyester/polyurethane mass ratio=85/15)
100% polyester (PET) woven fabric
100% nylon (Ny) woven fabric
100% cotton woven fabric

A treatment liquid comprising 6% by mass of the water-repellent agent composition according to any one of the Examples, Reference Example, and Comparative Example, 0.6% by mass of a blocked isocyanate crosslinking agent (NK Assist NY-50), and the remainder being pure water was prepared. Each of the treatment fabrics above was immersed in the obtained treatment liquid at normal pressure and 20±5° C. for 30 s, and then heat-treated at 150° C. for 2 min to obtain a fiber product. The obtained fiber product was subjected to the following evaluations.

### Evaluation of Water-Repellent Agent Composition and Fiber Product

### Storage Stability of Water-Repellent Agent Composition

100 g of the water-repellent agent composition according to any one of the Examples, Reference Example, and Comparative Example was placed in a glass jar (140-ml wide-opening sample bottle (mayonnaise jar)), sealed, and left to store at room temperature (20±5° C.). After two weeks, the amount of floating matter present in the water-repellent agent composition inside the glass jar was visually evaluated based on the criteria below. The results are shown in Tables 4 to 6.
Excellent: No presence of floating matter at all, uniform
Good: Floating matter less than 5% of liquid surface
Fair: Floating matter 5% or greater and less than 10% of liquid surface
Poor: Floating matter 10% or greater of liquid surface

### Initial Water Repellency of Fiber Product

The fiber product was tested in accordance with JIS L 1092 (2009), 7.2 Water repellency test (spray test) at a shower water temperature of 20° C. Results were visually evaluated with the following ratings. Note that, a “+” was added to a rating when characteristics were slightly better, and a “−” was added to a rating when characteristics were slightly inferior. Characteristics were evaluated in increments of 5 when the characteristics fall between the criteria below (for example, 95, 85, or 75). The results are shown in Tables 4 to 6.
Water repellency: Condition
100: No wetting or water droplets deposited on front surface
90: No wetting but shows small water droplets deposited on front surface
80: Shows wetting in form of small individual droplets on front surface
70: Shows wetting on half of front surface, indicates condition in which small individual portions of wetness penetrated the fabric
50: Shows wetness over the entire front surface
0: Shows wetness over the entirety of front and back surfaces

### Durable Water Repellency of Fiber Product

In accordance with Method 103 of JIS L 0217 (1995), the fiber product after subjected to washing 20 times (L-20) was evaluated for water repellency by the same procedure as the above initial water repellency.

### Chalk Mark Evaluation of Fiber Product

The surface of the fiber product was scratched with a claw and visually evaluated on the five-point scale indicated below. The results are shown in Tables 4 to 6.
5: Clear claw marks are observed.
4: Claw marks are observed.
3: Slight claw marks are observed.
2: Almost no claw marks are observed.
1: No claw marks at all

TABLE 1
Synthesis Examples of organo-modified silicone

| | | | | | | | | | | Compar- |
|---|---|---|---|---|---|---|---|---|---|---|
| | | Synthesis | Synthesis | Synthesis | Synthesis | Synthesis | Synthesis | Synthesis | Synthesis | ative |
| | | Example | Example | Example | Example | Example | Example | Example | Example | Synthesis |
| Formulation (equivalent ratio) | | 1 | 2 | 3 | 4 | 5 | 6 | 7 | 8 | Example 1 |
| Methyl | H silicone 1 | 1 | | | | | | | | |
| hydrogen | (90:10) | | | | | | | | | |
| silicone | H silicone 2 | | 1 | | | | | | | |
| (SiH:SiCH₃ | (60:40) | | | | | | | | | |
| molar ratio | H silicone 3 | | | 1 | | 1 | 1 | 1 | 1 | 1 |
| in parentheses) | (50:50) | | | | | | | | | |
| | H silicone 4 | | | | 1 | | | | | |
| | (30:70) | | | | | | | | | |
| α-Olefin | 1-Octene | | | | | 1 | | | | |
| (number of | (C8) | | | | | | | | | |
| carbon atoms | 1-Octadecene | 1 | 1 | 1 | 1 | | | | | |
| in R²³ of | (C18) | | | | | | | | | |
| formula (1) | 1-Docosene | | | | | | 1 | | | |
| in parentheses) | (C22) | | | | | | | | | |
| | 1-Hexacosene | | | | | | | 1 | | |
| | (C26) | | | | | | | | | |
| | 1-Dotriacontene | | | | | | | | 1 | |
| | (C32) | | | | | | | | | |
| | 1-Propene | | | | | | | | | 1 |
| | (C3) | | | | | | | | | |

TABLE 2
Preparation Examples of organo-modified silicone emulsion dispersion body

| | | Preparation Example | | | | | | | | | | |
|---|---|---|---|---|---|---|---|---|---|---|---|---|
| Formulation (parts by mass) | | α1 | α2 | α3 | α4 | α5 | α6 | α7 | α8 | α9 | α10 | α11 |
| Organo- | Synthesis Example 1 | 30 | | | | | | | | | | |
| modified | Synthesis Example 2 | | 30 | | | | | | | | | |
| silicone | Synthesis Example 3 | | | 30 | | | | | | 30 | 30 | 30 |
| (α) | Synthesis Example 4 | | | | 30 | | | | | | | |
| | Synthesis Example 5 | | | | | 30 | | | | | | |
| | Synthesis Example 6 | | | | | | 30 | | | | | |
| | Synthesis Example 7 | | | | | | | 30 | | | | |
| | Synthesis Example 8 | | | | | | | | 30 | | | |
| Comparison | Comparative Synthesis | | | | | | | | | | | |
| with (α) | Example 1 | | | | | | | | | | | |
| Organic | Isoparaffin | 30 | 30 | 30 | 30 | 30 | 30 | 30 | 30 | 60 | 15 | 7.5 |
| solvent | (10 to 16 carbon atoms) | | | | | | | | | | | |
| (γ) | Mineral oil (normal | | | | | | | | | | | |
| | alkane having 12 carbon | | | | | | | | | | | |
| | atoms) | | | | | | | | | | | |
| | Mineral spirit | | | | | | | | | | | |
| | (boiling point: 160 to | | | | | | | | | | | |
| | 180° C.) | | | | | | | | | | | |
| | 2,2,4-Trimethyl-1,3- | | | | | | | | | | | |
| | pentanediol diisobutyrate | | | | | | | | | | | |
| Water- | Tripropylene glycol | | | | | | | | | | | |
| soluble | (TPG) | | | | | | | | | | | |
| organic | Dipropylene glycol (DPG) | | | | | | | | | | | |
| solvent | Butyl diglycol | | | | | | | | | | | |
| Emulsifier | Sorbitan fatty acid ester | 3 | 3 | 3 | 3 | 3 | 3 | 3 | 3 | 3 | 3 | 3 |
| | (HLB 7 or less) | | | | | | | | | | | |
| | Polyoxyethlene alkyl | 4.5 | 4.5 | 4.5 | 4.5 | 4.5 | 4.5 | 4.5 | 4.5 | 4.5 | 4.5 | 4.5 |
| | ether | | | | | | | | | | | |
| | (HLB 8 to 14) | | | | | | | | | | | |
| | Cationic surfactant: alkyl | 0.75 | 0.75 | 0.75 | 0.75 | 0.75 | 0.75 | 0.75 | 0.75 | 0.75 | 0.75 | 0.75 |
| | (C16-18) trimethyl | | | | | | | | | | | |
| | ammonium chloride | | | | | | | | | | | |

| | | | | | | | | | | | |
|---|---|---|---|---|---|---|---|---|---|---|---|
| Formulation component total | 68.25 | 68.25 | 68.25 | 68.25 | 68.25 | 68.25 | 68.25 | 68.25 | 98.25 | 53.25 | 45.75 |
| Pure water | 31.75 | 31.75 | 31.75 | 31.75 | 31.75 | 31.75 | 31.75 | 31.75 | 1.75 | 46.75 | 54.25 |

| | | | | | | Comparative Preparation | | | |
|---|---|---|---|---|---|---|---|---|---|
| | | Preparation Example | | | | Example | | | |
| Formulation (parts by mass) | | α12 | α13 | α14 | α15 | α1 | α2 | α3 | α4 |
| Organo- | Synthesis Example 1 | | | | | | | | |
| modified | Synthesis Example 2 | | | | | | | | |
| silicone | Synthesis Example 3 | 30 | 30 | 30 | 30 | | | | 30 |
| (α) | Synthesis Example 4 | | | | | | | | |
| | Synthesis Example 5 | | | | | | | | |
| | Synthesis Example 6 | | | | | | | | |
| | Synthesis Example 7 | | | | | 30 | | | |
| | Synthesis Example 8 | | | | | | 30 | | |
| Comparison | Comparative Synthesis | | | | | | | 30 | |
| with (α) | Example 1 | | | | | | | | |
| Organic | Isoparaffin | | | | 22.5 | | | | |
| solvent | (10 to 16 carbon atoms) | | | | | | | | |
| (γ) | Mineral oil (normal | 30 | | | | | | | |
| | alkane having 12 carbon | | | | | | | | |
| | atoms) | | | | | | | | |
| | Mineral spirit | | 30 | | | | | | |
| | (boiling point: 160 to | | | | | | | | |
| | 180° C.) | | | | | | | | |
| | 2,2,4-Trimethyl-1,3- | | | 30 | | | | | |
| | pentanediol diisobutyrate | | | | | | | | |
| Water- | Tripropylene glycol | | | | 7.5 | 8.4 | | | |
| soluble | (TPG) | | | | | | | | |
| organic | Dipropylene glycol (DPG) | | | | | | 8.4 | | |
| solvent | Butyl diglycol | | | | | | | 7.5 | |
| Emulsifier | Sorbitan fatty acid ester | 3 | 3 | 3 | 3 | 3 | 3 | 3 | 3 |
| | (HLB 7 or less) | | | | | | | | |
| | Polyoxyethlene alkyl | 4.5 | 4.5 | 4.5 | 4.5 | 4.5 | 4.5 | 4.5 | 4.5 |
| | ether | | | | | | | | |
| | (HLB 8 to 14) | | | | | | | | |
| | Cationic surfactant: alkyl | 0.75 | 0.75 | 0.75 | 0.75 | 0.75 | 0.75 | 0.75 | 0.75 |
| | (C16-18) trimethyl | | | | | | | | |
| | ammonium chloride | | | | | | | | |

| | | | | | | | | |
|---|---|---|---|---|---|---|---|---|
| Formulation component total | 68.25 | 68.25 | 68.25 | 68.25 | 46.65 | 46.65 | 45.75 | 38.25 |
| Pure water | 31.75 | 31.75 | 31.75 | 31.75 | 53.35 | 69.4 | 54.25 | 61.75 |

TABLE 3
Preparation Examples of water-repellent polymer dispersion body

| | | | | | | | | | | | | | Compar- |
|---|---|---|---|---|---|---|---|---|---|---|---|---|---|
| | | | | | | | | | | | | | ative |
| | | | | | | | | | | | | | Preparation |
| | | Preparation Example | | | | | | | | | | | Example |
| Formulation (g) | | β1 | β2 | β3 | β4 | β5 | β6 | β7 | β8 | β9 | β10 | β11 | β1 |
| Monomer | Stearyl acrylate (SA) | 24.0 | 24.0 | 28.5 | 30.0 | 15.0 | 15.0 | | | 24.0 | 29.4 | 23.4 | |
| (A-1) | Lauryl acrylate | | | | | | | 30.0 | | | | | |
| | Behenyl acrylate | | | | | | | | 30.0 | | | | |
| | Stearyl methacrylate | | | | | | | | | 6.0 | | | |
| | (SMA) | | | | | | | | | | | | |
| Comparison | Decyl acrylate (C10) | | | | | | | | | | | | 30.0 |
| with (A-1) | | | | | | | | | | | | | |
| Monomer | C6SFMA | | | | | 15.0 | | | | | | | |
| (A-f) | (CF₃CF₂—(CF₂CF₂)₂— | | | | | | | | | | | | |
| | CH₂CH₂OCOC(CH₃)═CH₂) | | | | | | | | | | | | |
| | C6SFCLA | | | | | | 15.0 | | | | | | |
| | (CF₃CF₂—(CF₂CF₂)₂— | | | | | | | | | | | | |
| | CH₂CH₂OCOC(Cl)═CH₂) | | | | | | | | | | | | |
| Monomer | Diacetone acrylamide | | | | | | | | | | 0.6 | 0.6 | |
| (A-2) | (DAAM) | | | | | | | | | | | | |
| Monomer | Vinyl chloride | 6.0 | | | | | | | | | | 6.0 | |
| (VC) | Vinylidene chloride | | 6.00 | | | | | | | | | | |
| Reactive | Latemul PD-420 | | | 0.75 | | | | | | | | | |
| activator (B) | Latemul PD-430 | | | 0.75 | | | | | | | | | |
| Emulsifier | Noigen XL-100 (14.7) | 0.2 | 0.2 | 0.2 | 0.2 | 0.2 | 0.2 | 0.2 | 0.2 | 0.2 | 0.2 | 0.2 | 0.2 |
| (HLB in | Noigen XL-60 (12.5) | 1.3 | 1.3 | 1.3 | 1.3 | 1.3 | 1.3 | 1.3 | 1.3 | 1.3 | 1.3 | 1.3 | 1.3 |
| parentheses) | Noigen XL-40 (10.5) | 0.5 | 0.5 | 0.5 | 0.5 | 0.5 | 0.5 | 0.5 | 0.5 | 0.5 | 0.5 | 0.5 | 0.5 |
| Emulsifica- | Alkyl (C16-18) trimethyl | 0.4 | 0.4 | 0.4 | 0.4 | 0.4 | 0.4 | 0.4 | 0.4 | 0.4 | 0.4 | 0.4 | 0.4 |
| tion aid | ammonium chloride | | | | | | | | | | | | |
| Medium | Tripropylene glycol | 12.5 | 12.5 | 12.5 | 12.5 | 12.5 | 12.5 | 12.5 | 12.5 | 12.5 | 12.5 | 12.5 | 12.5 |
| | Water | 54.8 | 54.8 | 54.8 | 54.8 | 53.8 | 52.8 | 54.8 | 54.8 | 54.8 | 54.8 | 54.8 | 54.8 |
| Initiator | Azobis(isobutylamidine) | 0.2 | 0.2 | 0.2 | 0.2 | 1.2 | 2.2 | 0.2 | 0.2 | 0.2 | 0.2 | 0.2 | 0.2 |
| | dihydrochloride | | | | | | | | | | | | |
| Chain | Dodecyl mercaptan | 0.08 | 0.08 | 0.08 | 0.08 | 0.08 | 0.08 | 0.08 | 0.08 | 0.08 | 0.08 | 0.08 | 0.08 |
| transfer | | | | | | | | | | | | | |
| agent | | | | | | | | | | | | | |

TABLE 4
Manufacturing Examples of water-repellent agent composition

| | | | | | Example A4 | Comparative | Comparative |
|---|---|---|---|---|---|---|---|
| | | | | | Polymeriza- | Example A1 | Example A2 |
| | | | | | tion of | Polymerization | Polymerization |
| | | | Example A2 | | monomer | of monomer | of monomer |
| | | | Polymerization | | component as | component as | component as |
| | | | of monomer | | raw material | raw material | raw material |
| | | Example A1 | component as | | of water- | of water- | of water- |
| | | Mixing of | raw material | Example A3 | repellent | repellent | repellent |
| | | emulsion | of water- | Further | polymer (β) | polymer (β) | polymer (β) |
| | | dispersion body | repellent | homo- | in mixture | in mixture | in mixture |
| | | of organo- | polymer (β), | genization | of organo- | of organo- | of organo- |
| | | modified | in presence | treatment | modified | modified | modified |
| | | silicone (α) and | of emulsion | of water- | silicone (α), | silicone (α), | silicone (α), |
| | | emulsion | dispersion body | repellent | above | above monomer | above monomer |
| | | dispersion body | of organo- | agent | monomer | component, and | component, and |
| | | of water- | modified | composition | component, | comparative | comparative |
| Description of | | repellent | silicone | of Example | and organic | organic | organic |
| manufacturing method | | polymer (β) | (α) | A1 | solvent (γ) | solvent | solvent |
| Storage stability of water- | | good | excellent | excellent | excellent | fair | fair |
| repellent agent composition | | | | | | | |
| Water | Initial water | 95 | 95 | 95 | 95 | 75 | 80 |
| repellency | repellency | | | | | | |
| (polyester) | Durable water | 95 | 95 | 95 | 95 | 70 | 75 |
| | repellency (L-20) | | | | | | |
| Water | Initial water | 95 | 95 | 95 | 95 | 75 | 80 |
| repellency | repellency | | | | | | |
| (nylon) | Durable water | 95 | 95 | 95 | 95 | 70 | 75 |
| | repellency (L-20) | | | | | | |
| Water | Initial water | 90+ | 90+ | 90+ | 90+ | 75 | 80 |
| repellency | repellency | | | | | | |
| (PET/PU) | Durable water | 90+ | 90+ | 90+ | 90+ | 70 | 75 |
| | repellency (L-20) | | | | | | |

TABLE 5

| | | | Example | | | | | | | | | | | | | | | | | |
|---|---|---|---|---|---|---|---|---|---|---|---|---|---|---|---|---|---|---|---|---|
| Formulation (parts by mass) | | | B1 | B2 | B3 | B4 | B5 | B6 | B7 | B8 | B9 | B10 | B11 | B12 | B13 | B14 | B15 | B16 | B17 | B18 |
| Water-repellent | Preparation | C18 | 90 | 80 | 30 | 40 | 80 | 80 | 80 | 80 | 80 | 80 | 80 | 80 | 80 | 80 | 80 | 80 | 80 | 80 |
| polymer | Example β4 | | | | | | | | | | | | | | | | | | | |
| dispersion body | | | | | | | | | | | | | | | | | | | | |
| Organo-modified | Preparation | H silicone 1/C18/ | 10 | 20 | 70 | 60 | | | | | | | | | | | | | | |
| silicone emulsion | Example α1 | isoparaffin | | | | | | | | | | | | | | | | | | |
| dispersion body | Preparation | H silicone 2/C18/ | | | | | 20 | | | | | | | | | | | | | |
| | Example α2 | isoparaffin | | | | | | | | | | | | | | | | | | |
| | Preparation | H silicone 3/C18/ | | | | | | 20 | | | | | | | | | | | | |
| | Example α3 | isoparaffin | | | | | | | | | | | | | | | | | | |
| | Preparation | H silicone 4/C18/ | | | | | | | 20 | | | | | | | | | | | |
| | Example α4 | isoparaffin | | | | | | | | | | | | | | | | | | |
| | Preparation | H silicone 3/C8/ | | | | | | | | 20 | | | | | | | | | | |
| | Example α5 | isoparaffin | | | | | | | | | | | | | | | | | | |
| | Preparation | H silicone 3/C22/ | | | | | | | | | 20 | | | | | | | | | |
| | Example α6 | isoparaffin | | | | | | | | | | | | | | | | | | |
| | Preparation | H silicone 3/C26/ | | | | | | | | | | 20 | | | | | | | | |
| | Example α7 | isoparaffin | | | | | | | | | | | | | | | | | | |
| | Preparation | H silicone 3/C32/ | | | | | | | | | | | 20 | | | | | | | |
| | Example α8 | isoparaffin | | | | | | | | | | | | | | | | | | |
| | Preparation | H silicone 3/C18/ | | | | | | | | | | | | 20 | | | | | | |
| | Example α9 | isoparaffin | | | | | | | | | | | | | | | | | | |
| | | (increased | | | | | | | | | | | | | | | | | | |
| | | amount) | | | | | | | | | | | | | | | | | | |
| | Preparation | H silicone 3/C18/ | | | | | | | | | | | | | 20 | | | | | |
| | Example α10 | isoparaffin | | | | | | | | | | | | | | | | | | |
| | | (reduced amount) | | | | | | | | | | | | | | | | | | |
| | Preparation | H silicone 3/C18/ | | | | | | | | | | | | | | 20 | | | | |
| | Example α11 | isoparaffin | | | | | | | | | | | | | | | | | | |
| | | (reduced amount) | | | | | | | | | | | | | | | | | | |
| | Preparation | H silicone 3/C18/ | | | | | | | | | | | | | | | 20 | | | |
| | Example α12 | mineral oil | | | | | | | | | | | | | | | | | | |
| | Preparation | H silicone 3/C18/ | | | | | | | | | | | | | | | | 20 | | |
| | Example α13 | mineral spirit | | | | | | | | | | | | | | | | | | |
| | Preparation | H silicone 3/C18/ | | | | | | | | | | | | | | | | | 20 | |
| | Example α14 | ester | | | | | | | | | | | | | | | | | | |
| | Preparation | H silicone 3/C18/ | | | | | | | | | | | | | | | | | | 20 |
| | Example α15 | isoparaffin/TPG | | | | | | | | | | | | | | | | | | |
| Evaluation | Water | Initial water | 90+ | 90+ | 90+ | 90+ | 90+ | 90+ | 90+ | 85 | 90+ | 95 | 95 | 90+ | 90+ | 90+ | 90+ | 90+ | 90+ | 90+ |
| | repellency | repellency | | | | | | | | | | | | | | | | | | |
| | (PET/PU) | Durable water | 90+ | 90+ | 90+ | 90+ | 90+ | 90+ | 90+ | 85 | 90+ | 95 | 95 | 90+ | 90+ | 90+ | 90+ | 90+ | 90+ | 90+ |
| | | repellency (L-20) | | | | | | | | | | | | | | | | | | |
| | Water | Initial water | 95 | 95 | 95 | 95 | 95 | 95 | 95 | 90 | 95 | 100 | 100 | 95 | 95 | 95 | 95 | 95 | 95 | 95 |
| | repellency | repellency | | | | | | | | | | | | | | | | | | |
| | (PET) | Durable water | 95 | 95 | 95 | 95 | 95 | 95 | 95 | 90 | 95 | 100 | 100 | 95 | 95 | 95 | 95 | 95 | 95 | 95 |
| | | repellency (L-20) | | | | | | | | | | | | | | | | | | |
| | Water | Initial water | 95 | 95 | 95 | 95 | 95 | 95 | 95 | 90 | 95 | 100 | 100 | 95 | 95 | 95 | 95 | 95 | 95 | 95 |
| | repellency | repellency | | | | | | | | | | | | | | | | | | |
| | (Ny) | Durable water | 95 | 95 | 95 | 95 | 95 | 95 | 95 | 90 | 95 | 100 | 100 | 95 | 95 | 95 | 95 | 95 | 95 | 95 |
| | | repellency (L-20) | | | | | | | | | | | | | | | | | | |
| | Water | Initial water | 75 | 75 | 75 | 75 | 75 | 75 | 75 | 70 | 75 | 80 | 80 | 75 | 75 | 75 | 75 | 75 | 75 | 75 |
| | repellency | repellency | | | | | | | | | | | | | | | | | | |
| | (cotton) | Durable water | 75 | 75 | 75 | 75 | 75 | 75 | 75 | 70 | 75 | 80 | 80 | 75 | 75 | 75 | 75 | 75 | 75 | 75 |
| | | repellency (L-20) | | | | | | | | | | | | | | | | | | |

| | | | | | | | | | | | | | | | | | | |
|---|---|---|---|---|---|---|---|---|---|---|---|---|---|---|---|---|---|---|
| Chalk mark | 2 | 3 | 5 | 5 | 3 | 3 | 3 | 4 | 3 | 2 | 2 | 3 | 3 | 3 | 3 | 3 | 3 | 3 |
| Storage stability of | good | good | good | good | good | good | good | good | good | good | good | good | good | good | good | good | good | good |
| water-repellent composition | | | | | | | | | | | to | | | | | | to | |
| (room temperature, 2 weeks) | | | | | | | | | | | fair | | | | | | fair | |

TABLE 6

| | | | | | | | | | | | | | | | | Reference | | | | | | | | |
|---|---|---|---|---|---|---|---|---|---|---|---|---|---|---|---|---|---|---|---|---|---|---|---|---|
| | | | Example | | | | | | | | | | | | | Example | Comparative Example | | | | | | | |
| Formulation (parts by mass) | | | B19 | B20 | B21 | B22 | B23 | B24 | B25 | B26 | B27 | B28 | B29 | B30 | B31 | B1 | B1 | B2 | B3 | B4 | B5 | B6 | B7 | B8 |
| Water- | Preparation | C18/viny1 | 80 | 70 | | | | | | | | | | | | | | | | | | | | |
| repellent | Example β1 | chloride | | | | | | | | | | | | | | | | | | | | | | |
| polymer | Preparation | C18/ | | | 80 | | | | | | | | | | | | | | | | | | | |
| dispersion | Example β2 | vinylidene | | | | | | | | | | | | | | | | | | | | | | |
| body | | chloride | | | | | | | | | | | | | | | | | | | | | | |
| | Preparation | C18/ | | | | 80 | | | | | | | | | | | | | | | | | | |
| | Example β3 | Latemul | | | | | | | | | | | | | | | | | | | | | | |
| | Preparation | C18 | | | | | 70 | | | | | | | | | | | 100 | 90 | 80 | | | | |
| | Example β4 | | | | | | | | | | | | | | | | | | | | | | | |
| | Preparation | C18/ | | | | | | 80 | | | | | | | | | | | | | 100 | 90 | | |
| | Example β5 | C6SFMA | | | | | | | | | | | | | | | | | | | | | | |
| | Preparation | C18/ | | | | | | | 80 | | | | | | | | | | | | | | 100 | |
| | Example β6 | C6SFCLA | | | | | | | | | | | | | | | | | | | | | | |
| | Preparation | C12 | | | | | | | | 80 | | | | | | | | | | | | | | |
| | Example β7 | | | | | | | | | | | | | | | | | | | | | | | |
| | Preparation | C22 | | | | | | | | | 80 | | | | | | | | | | | | | |
| | Example β8 | | | | | | | | | | | | | | | | | | | | | | | |
| | Preparation | C18/SMA | | | | | | | | | | 80 | | | | | | | | | | | | |
| | Example β9 | | | | | | | | | | | | | | | | | | | | | | | |
| | Preparation | C18/ | | | | | | | | | | | 80 | | | | | | | | | | | 80 |
| | Example β10 | DAAM | | | | | | | | | | | | | | | | | | | | | | |
| | Preparation | C18/DAAM/ | | | | | | | | | | | | 80 | 70 | | | | | | | | | |
| | Example β11 | vinyl | | | | | | | | | | | | | | | | | | | | | | |
| | | chloride | | | | | | | | | | | | | | | | | | | | | | |
| | Comparative | C10 | | | | | | | | | | | | | | 80 | | | | | | | | |
| | Preparation | | | | | | | | | | | | | | | | | | | | | | | |
| | Example β1 | | | | | | | | | | | | | | | | | | | | | | | |
| Organo- | Preparation | H silicone | | | | | | | | | | | | | | 20 | 100 | | | | | | | |
| modified | Example α1 | 1/C18/ | | | | | | | | | | | | | | | | | | | | | | |
| silicone | | isoparaffin | | | | | | | | | | | | | | | | | | | | | | |
| emulsion | Preparation | H silicone | 20 | 30 | 20 | 20 | 20 | 20 | 20 | 20 | 20 | 20 | 20 | 20 | 30 | | | | | | | | | |
| dispersion | Example α2 | 2/C18/ | | | | | | | | | | | | | | | | | | | | | | |
| body | | isoparaffin | | | | | | | | | | | | | | | | | | | | | | |
| | Comparative | H silicone | | | | | | | | | | | | | | | | | | | | 10 | | |
| | Preparation | 3/C26/TPG | | | | | | | | | | | | | | | | | | | | | | |
| | Example α1 | | | | | | | | | | | | | | | | | | | | | | | |
| | Comparative | H silicone | | | | | | | | | | | | | | | | | 10 | | | | | |
| | Preparation | 3/C32/DPG | | | | | | | | | | | | | | | | | | | | | | |
| | Example α2 | | | | | | | | | | | | | | | | | | | | | | | |
| | Comparative | H silicone | | | | | | | | | | | | | | | | | | | | | | 20 |
| | Preparation | 3/C3/butyl | | | | | | | | | | | | | | | | | | | | | | |
| | Example α3 | diglycol | | | | | | | | | | | | | | | | | | | | | | |
| | Comparative | H silicone | | | | | | | | | | | | | | | | | | 20 | | | | |
| | Preparation | 3/C18/ | | | | | | | | | | | | | | | | | | | | | | |
| | Example α4 | no organic | | | | | | | | | | | | | | | | | | | | | | |
| | | solvent | | | | | | | | | | | | | | | | | | | | | | |
| Additional water-repellent | | Paraffin | | | | | 10 | | | | | | | | | | | | | | | | | |
| component dispersion body | | wax | | | | | | | | | | | | | | | | | | | | | | |
| Evaluation | Water | Initial water | 95 | 95 | 95 | 90+ | 90+ | 100 | 100 | 80 | 90+ | 90+ | 95 | 100 | 100 | 50 | 0 | 70 | 80 | 75 | 75 | 80 | 75 | 75 |
| | repellency | repellency | | | | | | | | | | | | | | | | | | | | | | |
| | (PET/PU) | Durable | 95 | 95 | 95 | 90+ | 90+ | 100 | 100 | 80 | 90+ | 90+ | 95 | 100 | 100 | 0 | 0 | 60 | 75 | 70+ | 70 | 75 | 70 | 70+ |
| | | water | | | | | | | | | | | | | | | | | | | | | | |
| | | repellency | | | | | | | | | | | | | | | | | | | | | | |
| | | (L-20) | | | | | | | | | | | | | | | | | | | | | | |
| | Water | Initial water | 100 | 100 | 100 | 95 | 95 | 100 | 100 | 80 | 95 | 95 | 100 | 100 | 100 | 50 | 0 | 70 | 80 | 80 | 75 | 80 | 75 | 80 |
| | repellency | repellency | | | | | | | | | | | | | | | | | | | | | | |
| | (PET) | Durable | 100 | 100 | 100 | 95 | 95 | 100 | 100 | 80 | 95 | 95 | 100 | 100 | 100 | 0 | 0 | 60 | 75 | 75 | 70 | 75 | 70 | 75 |
| | | water | | | | | | | | | | | | | | | | | | | | | | |
| | | repellency | | | | | | | | | | | | | | | | | | | | | | |
| | | (L-20) | | | | | | | | | | | | | | | | | | | | | | |
| | Water | Initial water | 100 | 100 | 100 | 95 | 95 | 100 | 100 | 80 | 95 | 95 | 100 | 100 | 100 | 50 | 0 | 70 | 80 | 80 | 80 | 80 | 80 | 80 |
| | repellency | repellency | | | | | | | | | | | | | | | | | | | | | | |
| | (Ny) | Durable | 100 | 100 | 100 | 95 | 95 | 100 | 100 | 80 | 95 | 95 | 100 | 100 | 100 | 0 | 0 | 60 | 75 | 75 | 75 | 75 | 75 | 75 |
| | | water | | | | | | | | | | | | | | | | | | | | | | |
| | | repellency | | | | | | | | | | | | | | | | | | | | | | |
| | | (L-20) | | | | | | | | | | | | | | | | | | | | | | |
| | Water | Initial water | 80 | 80 | 80 | 75 | 75 | 90 | 90 | 65 | 75 | 75 | 80 | 90 | 90 | 0 | 0 | 50 | 60 | 55 | 65 | 60 | 65 | 55 |
| | repellency | repellency | | | | | | | | | | | | | | | | | | | | | | |
| | (cotton) | Durable | 80 | 80 | 80 | 75 | 75 | 90 | 90 | 65 | 75 | 75 | 80 | 90 | 90 | 0 | 0 | 0 | 50 | 0-50 | 60 | 50 | 60 | 0-50 |
| | | water | | | | | | | | | | | | | | | | | | | | | | |
| | | repellency | | | | | | | | | | | | | | | | | | | | | | |
| | | (L-20) | | | | | | | | | | | | | | | | | | | | | | |

| | | | | | | | | | | | | | | | | | | | | | | |
|---|---|---|---|---|---|---|---|---|---|---|---|---|---|---|---|---|---|---|---|---|---|---|
| Chalk mark | 3 | 3 | 3 | 3 | 3 | 3 | 3 | 3 | 3 | 3 | 3 | 3 | 3 | 2 | 5 | 1 | 1 | 2 | 1 | 1 | 1 | 3 |
| Storage stability of | good | good | good | good | good | good | good | good | good | good | good | good | good | good to | excel- | excel- | poor | poor | excel- | poor | excel- | poor |
| water-repellent agent | | | | | | | | | | | | | | fair | lent | lent | | | lent | | lent | |
| composition (room | | | | | | | | | | | | | | | | | | | | | | |
| temperature, 2 weeks) | | | | | | | | | | | | | | | | | | | | | | |

### Industrial Applicability

The water-repellent agent composition has excellent water repellency, durable water repellency, and storage stability, and can thus be suitably used in various fiber products.

1. A water-repellent agent composition, comprising an organo-modified silicone (α), a water-repellent polymer (β), and an organic solvent (γ), wherein
the organo-modified silicone (α) is represented by general formula (1): 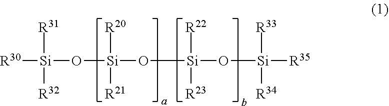
where in formula (1),
R²⁰, R²¹, and R²² each independently represent a hydrogen atom, a methyl group, an ethyl group, or an alkoxy group having 1 to 4 carbon atoms,
R²³ represents a hydrocarbon group having 8 to 40 carbon atoms comprising an aromatic ring, or an alkyl group having 8 to 40 carbon atoms,
R³⁰, R³¹, R³², R³³, R³⁴, and R³⁵ each independently represent a hydrogen atom, a methyl group, an ethyl group, an alkoxy group having 1 to 4 carbon atoms, a hydrocarbon group having 8 to 40 carbon atoms comprising an aromatic ring, or an alkyl group having 8 to 40 carbon atoms,
a represents an integer of 0 or greater; b represents an integer of 1 or greater; (a+b) is 10 to 200; when a is 2 or greater, each of R²⁰ and R²¹ present in plurality may be identical or different;
and when b is 2 or greater, each of R²² and R²³ present in plurality may be identical or different,
the water-repellent polymer (β) comprises a constituent unit derived from a monomer (A-1) represented by general formula (A-1): 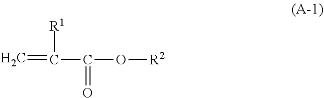
where in formula (A-1),
R¹ represents a hydrogen atom or a methyl group, and
R² represents a monovalent hydrocarbon group having 12 or more carbon atoms that may comprise a substituent, and/or a constituent unit derived from a monomer (A-f) represented by general formula (A-f): 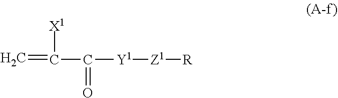
where in formula (A-f),
X¹ represents a hydrogen atom, a monovalent organic group, or a halogen atom,
Y¹ represents —O— or —NH—,
Z¹ represents a direct bond or a divalent organic group, and
R represents a fluoroalkyl having 1 to 20 carbon atoms, and
the organic solvent (γ) is an organic solvent in which an amount of water required to dissolve 1 g of the organic solvent at 20° C. is more than 10 mL.

2. The water-repellent agent composition according to claim 1, wherein an amount of the organo-modified silicone (α) relative to a total of 100 parts by mass of the organo-modified silicone (α) and the water-repellent polymer (β) is 10 to 90 parts by mass.

3. The water-repellent agent composition according to claim 1, wherein the water-repellent polymer (β) further comprises a constituent unit derived from a monomer (VC) of one or more selected from the group consisting of vinyl chloride and vinylidene chloride.

4. The water-repellent agent composition according to claim 1, wherein
the water-repellent polymer (β) further comprises a constituent unit derived from a monomer (A-2) represented by general formula (A-2): 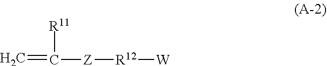
where in formula (A-2),
R¹¹ represents a hydrogen atom or a methyl group,
R¹² represents a divalent hydrocarbon group having 1 to 6 carbon atoms,
Z represents an ester group or an amide group, and
W represents a group represented by —CO—R¹³ (wherein R¹³ represents a monovalent hydrocarbon group having 1 to 4 carbon atoms), a —NH—CO—NH₂ group, or a group represented by formula (A-3):

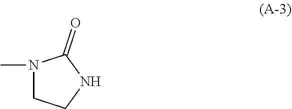

5. The water-repellent agent composition according to claim 1, wherein
the water-repellent polymer (β) further comprises a constituent unit derived from a reactive activator (B) of at least one selected from the group consisting of
(B1) a compound having a HLB of 7 to 18, represented by general formula (I-1): 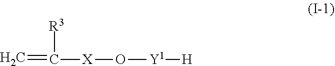
where in formula (I-1), R³ represents a hydrogen atom or a methyl group; X represents a linear or branched alkylene group having 1 to 6 carbon atoms; and Y¹ represents a divalent group comprising an alkyleneoxy group having 2 to 4 carbon atoms,
(B2) a compound having a HLB of 7 to 18, represented by general formula (II-1): 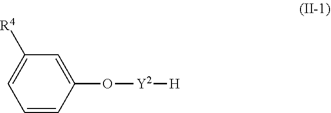
where in formula (II-1), R⁴ represents a monovalent unsaturated hydrocarbon group having 13 to 17 carbon atoms comprising a polymerizable unsaturated group; and Y² represents a divalent group comprising an alkyleneoxy group having 2 to 4 carbon atoms, and
(B3) a compound having a HLB of 7 to 18 and an alkylene oxide having 2 to 4 carbon atoms added to an oil or fat comprising a hydroxyl group and a polymerizable unsaturated group.

6. A water repellent aid for an acrylic water-repellent agent, comprising an organo-modified silicone (α) and an organic solvent (γ), wherein
the organo-modified silicone (α) is represented by general formula (1): 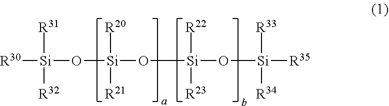
where in formula (1),
R²⁰, R²¹, and R²² each independently represent a hydrogen atom, a methyl group, an ethyl group, or an alkoxy group having 1 to 4 carbon atoms,
R²³ represents a hydrocarbon group having 8 to 40 carbon atoms comprising an aromatic ring or an alkyl group having 8 to 40 carbon atoms,
R³⁰, R³¹, R³², R³³, R³⁴, and R³⁵ each independently represent a hydrogen atom, a methyl group, an ethyl group, an alkoxy group having 1 to 4 carbon atoms, a hydrocarbon group having 8 to 40 carbon atoms comprising an aromatic group, or an alkyl group having 8 to 40 carbon atoms,
a represents an integer of 0 or greater; b represents an integer of 1 or greater; (a+b) is 10 to 200; when a is 2 or greater, each of R²⁰ and R²¹ present in plurality may be identical or different; and when b is 2 or greater, each of R²² and R²³ present in plurality may be identical or different, and
the organic solvent (γ) is an organic solvent in which an amount of water required to dissolve 1 g of the organic solvent at 20° C. is more than 10 mL.

7. A manufacturing method for the water-repellent agent composition according to claim 1, comprising
a mixing step of mixing an emulsion dispersion body comprising the organo-modified silicone (α) and the organic solvent (γ) with an emulsion dispersion body comprising the water-repellent polymer (β).

8. A manufacturing method for the water-repellent agent composition according to claim 1, comprising
a mixing step of mixing an emulsion dispersion body comprising the organo-modified silicone (α) and the organic solvent (γ) with a monomer component that is a raw material of the water-repellent polymer (3), and
a polymerization step of polymerizing the monomer component after the mixing step and/or during the mixing step to generate the water-repellent polymer (β).

9. A manufacturing method for the water-repellent agent composition according to claim 1, comprising
a mixing step of mixing the organo-modified silicone (α), a monomer component that is a raw material of the water-repellent polymer (β), and the organic solvent (γ), and
a polymerization step of polymerizing the monomer component after the mixing step and/or during the mixing step to generate the water-repellent polymer (β).

10. A water-repellent fiber product, comprising a fiber product and the water-repellent agent composition according to claim 1 deposited on the fiber product.

11. A manufacturing method for a water-repellent fiber product, comprising a step of treating a fiber product with a treatment liquid comprising a water-repellent agent composition according to claim 1.

12. The water-repellent agent composition according to claim 4, wherein the water-repellent polymer (β) further comprises a constituent unit derived from a monomer (VC) of one or more selected from the group consisting of vinyl chloride and vinylidene chloride.

13. The water-repellent agent composition according to claim 5, wherein the water-repellent polymer (β) further comprises a constituent unit derived from a monomer (VC) of one or more selected from the group consisting of vinyl chloride and vinylidene chloride.

14. A manufacturing method for the water-repellent agent composition according to claim 12, comprising
a mixing step of mixing an emulsion dispersion body comprising the organo-modified silicone (α) and the organic solvent (γ) with an emulsion dispersion body comprising the water-repellent polymer (β).

15. A manufacturing method for the water-repellent agent composition according to claim 12, comprising
a mixing step of mixing an emulsion dispersion body comprising the organo-modified silicone (α) and the organic solvent (γ) with a monomer component that is a raw material of the water-repellent polymer (β), and
a polymerization step of polymerizing the monomer component after the mixing step and/or during the mixing step to generate the water-repellent polymer (β).

16. A manufacturing method for the water-repellent agent composition according to claim 12, comprising
a mixing step of mixing the organo-modified silicone (α), a monomer component that is a raw material of the water-repellent polymer (β), and the organic solvent (γ), and
a polymerization step of polymerizing the monomer component after the mixing step and/or during the mixing step to generate the water-repellent polymer (β).

17. A manufacturing method for the water-repellent agent composition according to claim 13, comprising
a mixing step of mixing an emulsion dispersion body comprising the organo-modified silicone (α) and the organic solvent (γ) with an emulsion dispersion body comprising the water-repellent polymer (β).

18. A manufacturing method for the water-repellent agent composition according to claim 13, comprising
a mixing step of mixing an emulsion dispersion body comprising the organo-modified silicone (α) and the organic solvent (γ) with a monomer component that is a raw material of the water-repellent polymer (β), and
a polymerization step of polymerizing the monomer component after the mixing step and/or during the mixing step to generate the water-repellent polymer (β).

19. A manufacturing method for the water-repellent agent composition according to claim 13, comprising
a mixing step of mixing the organo-modified silicone (α), a monomer component that is a raw material of the water-repellent polymer (β), and the organic solvent (γ), and
a polymerization step of polymerizing the monomer component after the mixing step and/or during the mixing step to generate the water-repellent polymer (β).
